(19) United States
(12) Patent Application Publication
(10) Pub. No.: US 2025/0234293 A1
(43) Pub. Date: Jul. 17, 2025

(54) WIRELESS DEVICE, NODE AND METHODS PERFORMED THEREBY, FOR HANDLING A TRANSMISSION

(71) Applicant: Telefonaktiebolaget LM Ericsson (publ), Stockholm (SE)

(72) Inventors: Andreas HÖGLUND, SOLNA (SE); Mohammad MOZAFFARI, FREMONT, CA (US); Olof LIBERG, ENSKEDE (SE)

(73) Assignee: Telefonaktiebolaget LM Ericsson (publ), Stockholm (SE)

(21) Appl. No.: 18/839,309

(22) PCT Filed: Feb. 17, 2023
(86) PCT No.: PCT/SE2023/050148

§ 371 Date: Aug. 16, 2024

Related U.S. Application Data
(60) Provisional application No. 63/268,210, filed on Feb. 18, 2022.

(51) Int. Cl. H04W 52/02

(52) U.S. Cl. CPC H04W 52/0235; H04W 52/0274

(57) ABSTRACT

A method performed by a wireless device (131). The wireless device (111) operates in a wireless communications network (100). The device monitors (504), in sleep mode, using a first receiver, which is a WUR, whether a first radio signal is received. The signal indicates the device is in coverage of a node (101). The monitoring (504) is performed with the proviso the device has obtained information to send. The device also sends (508) the information based on whether it receives the signal. If the device receives the signal, the signal wakes-up a second receiver, sends the information using the second receiver, goes back to sleep, and c) refrains from monitoring (504) with the proviso the device lacks further information to be sent. If the device fails to receive the signal, it stores the information and b) stays in sleep mode, until it sends the information, using the second receiver, when the wireless device (131) receives the signal.

### CROSS-REFERENCE TO RELATED APPLICATIONS

This application is a 35 U.S.C. § 371 National Stage of International Patent Application No. PCT/SE2023/050148, filed 2023 Feb. 17, which claims priority to U.S. Provisional App. No. 63/268,210, filed on 2022 Feb. 18. The above-identified applications are incorporated by this reference.

### TECHNICAL FIELD

The present disclosure relates generally to a wireless device and methods performed thereby for handling a transmission. The present disclosure further relates generally to a node and methods performed thereby, for handling the transmission.

### BACKGROUND

Nodes within a communications network may be wireless devices such as e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone, and/or between a wireless device and a server via a Radio Access Network (RAN), and possibly one or more core networks, comprised within the communications network. Wireless devices may further be referred to as mobile telephones, cellular telephones, laptops, or tablets, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

Nodes may also be network nodes, such as radio network nodes, e.g., Transmission Points (TP). The communications network covers a geographical area which may be divided into cell areas, each cell area being served by a network node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station. The so-called 5G system, from a radio perspective started to be standardized in 3GPP, and the so-called New Radio (NR) is the name for the radio interface. NR architecture is being discussed in 3GPP. In the current concept, gNB denotes an NR BS, where one NR BS may correspond to one or more transmission/reception points.

The Fifth Generation (5G) Packet Core Network may be referred to as Next Generation (NG) Core Network, abbreviated as NG-CN, NGC or 5G CN.

### Internet of Things (IoT)

The Internet of Things (IoT) may be understood as an internetworking of communication devices, e.g., physical devices, vehicles, which may also be referred to as “connected devices” and “smart devices”, buildings and other items embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g., a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is, a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

Wake-up receiver (WUR), sometimes also referred to as ‘wake-up radio’, may be understood to relate to enabling a low power receiver in UEs, which, in case of the detection of a ‘Wake-up signal’ (WUS), may wake up the main, e.g., baseband/higher power, receiver to detect an incoming message, typically paging, e.g., the Physical Downlink Control Channel (PDCCH) in paging occasions (POs), scheduling the paging message on the Physical Downlink Shared Channel (PDSCH). The main benefit of employing WUR may be understood to be lowering energy consumption and longer device battery life, or at a fixed energy consumption, the downlink latency may be reduced, shorter Discontinued Reception (DRX)/duty-cycles, and more frequent checks for incoming transmissions.

FIG. 1 is a schematic diagram illustrating location of a WUS and the paging occasion to which it may be associated.

WUS for NB-IoT and LTE-M

### Release 15

In Rel-15, WUS was specified for NarrowBand IoT (NB-IoT) and Long Term Evolution for Machines (LTE-M). The main motivation was UE energy consumption reduction since, with the coverage enhancement, PDCCH may be repeated many times and the WUS may be relatively much shorter and hence may require less reception time for the UE. The logic may be understood to be that a UE may check for a WUS a certain time before its PO, and only if a WUS is detected the UE may continue to check for PDCCH in the PO, and if not, which is most of the time, the UE may go back to a sleep state to conserve energy. Due to the coverage enhancements, the WUS may be of variable length depending on the coverage of the UE, see FIG. 2.

FIG. 2 is a schematic diagram illustrating WUS for NB-IoT and LTE-M. As it is depicted in FIG. 2, a WUS may have a duration corresponding to a fraction of a configured maximum WUS duration. The end of the configured maximum WUS duration may be separated from the beginning of the PO the WUS may be associated with by a gap.

A WUS may be based on the transmission of a short signal that may indicate to the UE that it may need to continue to decode the Downlink (DL) control channel e.g., the full Narrowband PDCCH (NPDCCH) for NB-IoT. If such signal is absent, e.g., in Discontinuous Transmission (DTX) that is, if the UE does not detect it, then the UE may go back to sleep without decoding the DL control channel. The decoding time for a WUS may be considerably shorter than that of the full NPDCCH since it may only need to contain one bit of information, whereas the NPDCCH may contain up to 35 bits of information. This, in turn, may be understood to reduce UE power consumption and lead to longer UE battery life. The WUS may be understood to be transmitted only when there may be a paging for the UE. But if there is no paging for the UE, then the WUS may be understood to not be transmitted, implying a discontinuous transmission (DTX), and the UE may go back to deep sleep e.g., upon detecting DTX instead of WUS. This is illustrated in FIG. 1, where white blocks indicate possible WUS, and PO positions whereas the black boxes indicate actual WUS and PO positions.

The specification of Rel-15 WUS is spread out over several parts of the LTE 36-series standard, e.g., 36.211, 36.213, 36.304 and 36.331.

A UE may report its WUS capability to the network, and WUS gap capability, see below. Further WUS information was added to the paging message/request from a Mobility Management Entity (MME) to an eNB, see UE radio paging capabilities. An eNB may use WUS for paging the UE if and only if (IFF) 1) WUS is enabled in the cell, e.g., WUS-Config may be present in System Information (SI), and 2) the UE may support WUS according to the wakeUpSignal-r15 UE capability, see also the description of WUS gap below.

WUS was introduced for both LTE-M and NB-IoT with support for both DRX and extended DRX (eDRX), the former with a 1-to-1 mapping between the WUS and the PO, and for the latter in an addition with the possible configuration of 1-to-N, many, POs. An eNB may configure one WUS gap for UEs using DRX, and another one for UEs using eDRX, see e.g., TS 36.331, version 16.6.0, examples are given for NB-IoT, LTE-M is similar.

WUS-Config-NB information element

| | |
|---|---|
| WUS-Config-NB-r15 ::= | SEQUENCE { |
| maxDurationFactor-r15 | WUS-MaxDurationFactor-NB-r15, |
| numPOs-r15 | ENUMERATED {n1, n2, n4} |

DEFAULT n1,

| | |
|---|---|
| numDRX-CyclesRelaxed-r15 | ENUMERATED {n1, n2, n4, n8}, |
| timeOffsetDRX-r15 | ENUMERATED {ms40, ms80, |

ms160, ms240},

| | |
|---|---|
| timeOffset-eDRX-Short-r15 | ENUMERATED {ms40, ms80, ms160, ms240}, |
| timeOffset-eDRX-Long-r15 | ENUMERATED {ms1000, ms2000} |

OPTIONAL, -- Need OP
...
}

| | |
|---|---|
| WUS-ConfigPerCarrier-NB-r15 ::= | SEQUENCE { |
| maxDurationFactor-r15 | WUS-MaxDurationFactor-NB-r15 |

}

| | |
|---|---|
| WUS-MaxDurationFactor-NB-r15 ::= | ENUMERATED {one128th, one64th, one32th, |

one 16th,
oneEighth, oneQuarter, oneHalf}
WUS-Config-NB field descriptions
timeOffsetDRX
When DRX is used, non-zero gap from the end of the configured maximum WUS
duration to the associated PO, see TS 36.304 [4], clause 7.4 and TS 36.211 [21]. In
milliseconds. Value ms40 corresponds to 40ms, value ms80 corresponds to 80 ms and
so on.
timeOffset-eDRX-Short
When eDRX is used, the short non-zero gap from the end of the configured maximum
WUS duration to the associated PO, see TS 36.304 [4], clause 7.4 and TS 36.211 [21].
In milliseconds. Value ms40 corresponds to 40ms, value ms80 corresponds to 80 ms
and so on.
E-UTRAN configures timeOffset-eDRX-Short to a value longer than or equal to
timeOffsetDRX.
timeOffset-eDRX-Long
When eDRX is used, the long non-zero gap from the end of the configured maximum
WUS duration to the associated PO, see TS 36.304 [4], clause 7.4 and TS 36.211 [21].
In milliseconds. Value ms1000 corresponds to 1000 ms, value ms2000 corresponds to
2000 ms.

A UE may provide its capability for WUS by sending a UE-RadioPagingInfo-NB IE to the base station. The UE capabilities may also indicate the minimum WUS gaps required for the UE to be able to decode PDCCH in the associated PO, for DRX and eDRX, respectively, see TS 36.331, version 16.6.0:

UE-RadioPagingInfo-NB information element

| | |
|---|---|
| UE-RadioPagingInfo-NB-r13 ::= | SEQUENCE { |
| ue-Category-NB-r13 | ENUMERATED {nb1} |

OPTIONAL,

...,

| | |
|---|---|
| [[ multiCarrierPaging-r14 | ENUMERATED {true} |

OPTIONAL

]],

| | | |
|---|---|---|
| [[ | mixedOperationMode-r15 | ENUMERATED {supported} |

OPTIONAL,

| | |
|---|---|
| wakeUpSignal-r15 | ENUMERATED {true} |

| | |
|---|---|
| | OPTIONAL, |
| wakeUpSignalMinGap-eDRX-r15 | ENUMERATED {ms40, ms240, ms1000, ms2000} |
| | OPTIONAL, |
| multiCarrierPagingTDD-r15 | ENUMERATED {true} |
| | OPTIONAL |

]],

| | | |
|---|---|---|
| [[ | ue-Category-NB-r16 | ENUMERATED {nb2} |

OPTIONAL,

| | |
|---|---|
| groupWakeUpSignal-r16 | ENUMERATED {true} |

OPTIONAL,

| | |
|---|---|
| groupWakeUpSignalAlternation-r16 | ENUMERATED {true} |

OPTIONAL

]]
}
wakeUpSignalMinGap-eDRX
wakeUpSignalMinGap-eDRX may be understood to indicate the minimum gap the UE may
support between WUS or Group WUS (GWUS) and associated PO in case of eDRX in
Frequency Division Duplexing (FDD), as specified in TS 36.304, version 16.5.0. Value ms40
corresponds to 40 ms, value ms240 corresponds to 240 ms and so on. If this field is included,
the UE may be required to also indicate support for WUS or GWUS for paging in DRX.

At the end of Rel-15, a longer WUS gap of is or 2s was introduced to enable the use of a Wake-Up receiver (WUR), since, starting up the main baseband receiver if a WUR is used for the detection of WUS may take longer time. If this is supported in the cell, an eNB may include timeOffset-eDRX-Long in the WUS-Config in SI, see above. In TS 36.304, version 16.5.0, the UE behavior for monitoring paging with WUS is specified, and in Table 7.4-1, reproduced below, it is indicated which WUS time gap the UE and the eNB, may be required to apply depending on the reported UE capability.

7.4 Paging with Wake Up Signal

Paging with Wake Up Signal may only be used in the cell in which the UE most recently entered RRC_IDLE triggered by: a) reception of RRCEarlyDataComplete; or b) reception of RRCConnectionRelease not including noLastCellUpdate; or c) reception of RRCConnectionRelease including noLastCellUpdate and the UE was using (G)WUS in this cell prior to this Radio Resource Control (RRC) connection attempt.

If the UE is in RRC_IDLE, the UE may not be using GWUS according to clause 7.5 and the UE supports WUS, and WUS configuration may be provided in system information, the UE may be required to monitor WUS using the WUS parameters provided in System Information. When DRX is used and the UE detects WUS the UE may be required to monitor the following PO. When extended DRX is used and the UE detects WUS, the UE may be required to monitor the following numPOs POs or until a paging message including the UE's Non-Access Stratum (NAS) identity may be received, whichever may be earlier. If the UE does not detect WUS, the UE may not be required to monitor the following PO(s). If the UE missed a WUS occasion, e.g., due to cell reselection, it may monitor every PO until the start of the next WUS or until the paging time window (PTW) may end, whichever may be earlier.

$$numPOs = Number of consecutive Paging Occasions ( PO ) mapped to one WUS provided in system information where ( numPOs \geq 1 ) .$$

The WUS configuration, provided in system information, may include a time-offset between the end of WUS and the start of the first PO of the numPOs POs the UE may be required to monitor. The timeoffset in subframes, used to calculate the start of a subframe g0, see TS 36.213, version 16.7.1, may be defined as follows: i) for a UE using DRX, it may be the signalled timeoffsetDRX; ii) for a UE using eDRX, it may be the signalled timeoffset-eDRX-Short if timeoffset-eDRX-Long is not broadcasted; iii) for a UE using eDRX, it may be the value determined according to Table 7.4-1 if timeoffset-eDRX-Long is broadcasted.

TABLE 7.4-1
Determination of GAP between end of WUS and associated PO

| | | timeoffset-eDRX-Long | |
|---|---|---|---|
| | | 1000 ms | 2000 ms |
| UE Reported | 40 ms or | timeoffset-eDRX- | timeoffset-eDRX- |
| wakeUpSignalMinGap-eDRX | not | Short | Short |
| | reported | | |
| | 240 ms | timeoffset-eDRX- | timeoffset-eDRX- |
| | | Short | Short |
| | 1000 ms | timeoffset-eDRX- | timeoffset-eDRX- |
| | | Long | Long |
| | 2000 ms | timeoffset-eDRX- | timeoffset-eDRX- |
| | | Short | Long |

The timeoffset may be used to determine the actual subframe g0 as follows, taking into consideration resultant System Frame number (SFN) and/or Hyper Frame SFN (H-SFN) wrap-around of this computation:

g0=PO−timeoffset, where PO is the Paging Occasion subframe as defined in clause 7.1

For a UE using eDRX, the same timeoffset may apply between the end of WUS and associated first PO of the numPOs POs for all the WUS occurrences for a PTW.

The timeoffset, g0, may be used to calculate the start of the WUS as defined in TS 36.213, version 16.7.1.

In summary, the UE may only use WUR, or timeOffset-eDRX-Long, if it may be capable of starting up the main receiver as quickly as indicated by the value used in SI. If not, it may fall back to using timeOffset-eDRX-Short, without WUR.

Since UEs may share PO, the eNB may, in the worst case, have to transmit up to 3 WUSs for one PO, for example, corresponding to timeoffsetDRX, timeoffset-eDRX-Short, and timeoffset-eDRX-Long. FIG. 3 is a schematic diagram illustrating the use of eDRX and DRX WUS gaps for NB-IoT and LTE-M.

### WUS UE Grouping Objective in Rel-16

In the Rel-16 WID, it was agreed that WUS should be further developed to also include UE grouping, such that the number of UEs that may be triggered by a WUS may be further narrowed down to a smaller subset of the UEs that may be associated with a specific paging occasion (PO): The objective is to specify the following set of improvements for machine-type communications for Bandwidth reduced Low complexity/Coverage Enhancement (BLCE) UEs. Improved DL transmission efficiency and/or UE power consumption: . . . Specify support for UE-group wake-up signal (WUS) [RAN1, RAN2, RAN4]

The purpose may be understood to be to reduce the false paging rate, that is, to avoid that a given UE may be unnecessarily woken up by a WUS transmission intended for another UE. This feature may be referred to as Rel-16 group WUS, or GWUS. However, this is not directly related to WUR and will not further be explained here.

### Rel-17 NR PEI

In Rel-17, discussions started on introducing a WUS for NR, then called ‘Paging Early Indication’ (PEI). However, since at the time no coverage enhancement was specified for NR, the only gain for Rel-17 PEI was for scenarios where the small fraction of UEs may be in bad coverage and with large synchronization error due to the use of longer DRX cycles. The gain for such UEs was that, with the use of PEI, they may typically only have to acquire one Synchronisation Signal Block (SSB) before decoding PEI, instead of up to 3 SSBs if PEI is not used, value according to UE vendors. Accordingly, for most UEs, Rel-17 PEI may result in gains or increased performance.

Rel-17 PEI may also support UE grouping for false paging reduction, similar to the Rel-16 GWUS above, which may have some gains at higher paging load.

In RAN #93e it was agreed that PEI may be PDCCH-based, as seen in from the next subsection, making it much less interesting for WUR, since the main baseband receiver may be understood to be required for decoding PEI.

### Rel-18 NR WUR

In Rel-18, there has been rather large interest to introduce WUR for NR. As explained above, the only specification support needed to be able to use a WUR in the UE, may be understood to be the specification of a WUS and a long enough time gap between the WUS and the PDCCH in the PO, to allow the UE to start up the main receiver. Therefore, the main difference to Rel-17 PEI may be understood to be that the WUS in Rel-18 may be understood to not have to be PDCCH-based and allow for a simpler and low power receiver, that is, WUR with simple modulation and detection techniques, e.g., using On-Off Keying (OOK), modulation, and non-coherent detection.

In a Rel-18, a study item on “low-power wake-up signal and receiver for NR” was approved. The relevant justification and objective sections are reproduced below (RP-213645).

### Justification

5G systems are designed and developed targeting for both mobile telephony and vertical use cases. Besides latency, reliability, and availability, UE energy efficiency may be understood to be also critical to 5G. Currently, 5G devices may have to be recharged per week or day, depending on an individual's usage time. In general, 5G devices may consume tens of milliwatts in Radio Resource Control (RRC) idle/inactive state, and hundreds of milliwatts in RRC connected state. Designs to prolong battery life may be understood to be a necessity for improving energy efficiency as well as for better user experience.

Energy efficiency may be understood to be even more critical for UEs without a continuous energy source, e.g., UEs using small rechargeable and single coin cell batteries. Among vertical use cases, sensors and actuators may be deployed extensively for monitoring, measuring, charging, etc. Generally, their batteries may not be rechargeable and expected to last at least few years as described in TR 38.875. Wearables may include smart watches, rings, eHealth related devices, and medical monitoring devices. With typical battery capacity, it may be challenging to sustain up to 1-2 weeks as may be required.

The power consumption may depend on the configured length of wake-up periods, e.g., paging cycle. To meet the battery life requirements above, an eDRX cycle with large value may be expected to be used, resulting in high latency, which may be understood to not be suitable for such services with requirements of both long battery life and low latency. For example, in a fire detection and extinguishment use case, fire shutters may be understood to need to be closed and fire sprinklers may need to be turned on by the actuators within 1 to 2 seconds from the time the fire may be detected by sensors, a long eDRX cycle may not meet the delay requirements. eDRX may be understood to not be apparently suitable for latency-critical use cases. Thus, the intention may be understood to be to study an ultra-low power mechanism that may support low latency in Rel-18, e.g., lower than eDRX latency.

Currently, UEs may need to periodically wake up once per DRX cycle, which may dominate the power consumption in periods with no signalling or data traffic. If UEs are able to wake up only when they may be triggered, e.g., paging, power consumption may be dramatically reduced. This may be achieved by using a wake-up signal to trigger the main radio and a separate receiver which may have the ability to monitor wake-up signal with ultra-low power consumption. Main radio may work for data transmission and reception, which may be turned off or set to deep sleep unless it may be turned on.

The power consumption for monitoring wake-up signal may depend on the wake-up signal design and the hardware module of the wake-up receiver used for signal detecting and processing.

The study may need to primarily target low-power WUS/WUR for power-sensitive, small form-factor devices including IoT use cases, such as industrial sensors, controllers, and wearables. Other use cases may be understood to not be precluded, e.g., Extended Reality (XR)/smart glasses, smart phones.

As for the objective of SI, as opposed to the work on UE power savings in previous releases, this study may not require existing signals to be used as WUS. All WUS solutions identified may be able to operate in a cell supporting legacy UEs. Solutions may need to target substantial gains compared to the existing Rel-15/16/17 UE power saving mechanisms. Other aspects such as detection performance, coverage, UE complexity, may need to be covered by the evaluation.

The study item included the following objectives. One objective was to identify evaluation methodology, including the use cases, and Key Performance Indicators (KPIs) [RAN1]. Primarily, to target low-power WUS/WUR for power-sensitive, small form-factor devices including IoT use cases, such as industrial sensors, controllers, and wearables. Other use cases were not precluded. Another objective was to study and evaluate low-power wake-up receiver architectures [RAN1, RAN4]. A further objective was to study and evaluate wake-up signal designs to support wake-up receivers [RAN1, RAN4]. Yet another objective was to study and evaluate Layer 1 (L1) procedures and higher layer protocol changes needed to support the wake-up signals [RAN2, RAN1]. An additional objective was to study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead did not need to be included in the study [RAN1]. Note: The need for RAN2 evaluation may be triggered by RAN1 when necessary.

For more details on e.g., suggestions on WUR architecture and design, receiver power vs. sensitivity trade-off e.g., RP-212005, RP-212254, RP-212367, and RP-212427 which were submitted to RAN3 #93-e, may be also consulted.

The benefit of WUR may be understood to be to reduce the energy consumption of the receiver, such that unless there is any paging and data for the UE, it may remain in a power saving state. This may extend the battery life of the device, or alternatively enable shorter downlink latency, e.g., shorter DRX, at a fixed battery life. For short-range communication, the WUR power may be low enough, ˜3 uW, that this may even, in combination with energy harvesting, enable that the WUR may be continuously on without the need for a battery, that is, DRX or duty-cycling may be not used. This may be considered as a key enabler of battery-less devices towards 6G.

### IEEE WUR

In IEEE, the support for WUR has been specified to a greater extent than in 3GPP. That is, the focus was on low power WUR from the start, and the design may use WUR not only for receiving the WUS but also other control signals and signaling, such as synchronization and mobility information. This may be understood to allow the stations, corresponding to UEs in 3GPP, to only use the WUR when there may be no user-plane data transmission ongoing.

Similar to the 3GPP solution, the use of WUR may only be enabled in stations and not in access points (APs), that is, for downlink communication only. The AP may advertise that it has WUR operation capability, along with WUR configuration parameters, among other information, in which band/channel WUR may be operational, which may be different from the band/channel used for data transmission using the main receiver, e.g., WUR in 2.4 GHz band but data communication in 5 GHz band. Also, it may be noted that the WUR operating channel may be advertised in the beacon, and that the WUR discovery operating channel may be different from the WUR operating channel. Stations may then request to be configured with WUR mode of operation. This request may have to be granted by the AP, and in case it is granted, the station may be further configured/setup for WUR mode of operation, that is, the configuration may be only valid for the connection to the associated AP, and further, the configuration may have to be torn down/de-configured if WUR is not to be used anymore. Both continuous WUR, that is, the receiver open all the time, and duty-cycled WUR, that is, receiver only open during preconfigured time slots, mode of operations may be supported. For the latter, the length of the duty-cycles and on-time during wake up may be part of the WUR configuration.

Unlike the 3GPP solution, the WUR operation mode may be understood to be a “sub-state” of the regular operation and upon the detection of a WUS transmission from the AP, the station may resume the power saving mechanism it may have been configured with before entering the WUR operation mode. That is, IEEE has specified a number of different power saving mechanisms, and for example if duty-cycled monitoring of the downlink has been configured for the station, it may switch to that upon detection of the WUS, unlike the specified 3GPP mechanism which may only cover paging, and the UE may continue to monitor PDCCH if WUS is detected. In this way, the IEEE WUR functionality is more general, and may still allow for the station to, upon detection of WUS, “monitor paging” by checking in the beacon from the AP for which stations there is data, or for the station to directly respond with an uplink transmission.

A station receiving the IEEE WUS may need to synchronize to the wireless medium prior to performing any transmissions, that is, using synchronization information in the beacon from the AP, typically transmitted every 100 ms, or from the transmission to another station. Synchronization to the wireless medium may be understood to refer to the following in IEEE 802.11; a station changing from sleep to awake in order to transmit may have to perform channel clear assessment until it may receive one or more frames that may allow it to correctly set the virtual carrier sensing. This may be understood to be to prevent collisions with transmissions from hidden nodes. In sum, the virtual carrier sensing may tell a station to defer for a time period even if the wireless medium may appear to be idle, and may be set by receiving frames that may indicate the duration of an ongoing frame exchange. It may be noted that in WiFi typically, one beacon transmission may be enough to synchronize for the station, that is, no need to acquire several transmission due to poor coverage. Unlike operation in licensed bands, the station may also have to apply carrier sensing, and also possibly re-acquire channel sensing parameters, before uplink transmission.

The physical WUS in IEEE may contain complete frames which may have to be processed by the station. The drawback with this design may be understood to be that it may require more handling and processing in the station, that is, compared to a simple WUR design, which may trigger one pre-defined activity in case WUS may be detected. The benefit may be that it may contain more information and the solution may be more general. The IEEE WUS may contain information to indicate if the WUS may be a WUR synchronization beacon, see below, a WUR discovery beacon, see below, or a regular WUS, intended to wake the station up. The WUS may also contain proprietary frames, which may e.g., be used to directly turn actuators on/off. The transmission may use on/off keying (OOK) modulation, using Manchester coding, but may be using multi-carrier OOK which may be generated by an Orthogonal Frequency Division Multiplexing (OFDM) transmitter, that is, WUR may be enabled as a software upgrade in APs. The WUS may be 4 MHz wide, but a whole 20 MHz channel may be reserved. The WUS may start with a 20 MHz legacy preamble, to allow other stations to perform carrier sense, followed by 4 MHz Manchester coded OOK. Two data rates may be supported: 62.5 kbps and 250 kbps, and link adaptation may be up to the AP, each packet may be self-contained and include the data rate, that is, in the WUR there may be two possible synchronization words used to signal the data rate.

The WUS may contain the following information: a) Station Identifier (ID), or group ID, grouping of stations may be supported, b) payload up to 22 bytes, c) short frames may contain only basic information; which WUR frame type+addressing, d) ordinary frames may contain control information, and in addition proprietary information, e) WUR beacons may contain Basic Service Set Identifier (BSS-ID), synchronization information, time counter, f) similar structure for WUS and WUR beacons, synchronization words may indicate the data rate, the station may then detect the header, from this, the station may tell if it is WUS or beacon, then check body, g) WUR discovery frames may contain mobility related information to allow for lower power scan, see below.

Regarding mobility, both WUR synchronization beacons and WUR discovery beacons have been specified, which may only require the WUR to be used for reception, such that stations may stay in the WUR operation mode unless there may be data transmission for the station. That is, stations may only need to switch back to legacy Power Saving Mode (PSM) upon WUS detection, or when moving to a new AP. WUR synchronization beacons may be used by stations to obtain rough synchronization, for data transmission the legacy beacon may be required to still be acquired, and WUR discovery beacons may be used to carry (legacy) mobility information to enable quick/low energy scanning, allowing stations, only using the WUR, to get information related to local and roaming scans for nearby APs, e.g., Service Set Identity (SSID) and main radio operating channels, if the channel quality should deteriorate.

That is, in the WUR discovery beacon, the AP may indicate one or more Basic Service Set (BSS), and the BSS-ID may have a one-to-one mapping with the assigned SSID name, in which WUR may be supported such that stations may not have to scan all frequencies/channels. Since the WUR discovery beacon may contain the legacy mobility information, there may be some duplication/redundancy in the broadcasted information. This may allow for low power scanning, using only the WUR. Note however that mobility in IEEE may be restricted to the same AP, and that hand-over between APs etc. may not be supported in the same way as in 3GPP. If a station in WUR operation mode moves to a new AP, it may have to move out of WUR operation mode and use the main receiver to obtain the beacon, synchronization, configuration, and associate to the new AP.

### Battery-Less IoT

During the preparation phase of Release 18 in 3GPP, a similar solution for a lower UE segment for IoT was proposed. The device complexity may be really low and the form factor very small, and the devices may even be printable electronics. The main use cases may be barcode replacement, item tracking and status for logistics, automatic inventory, industrial application, agriculture, etc. Transmissions from the battery-less IoT devices has been proposed to be based either on backscattering communication or energy harvesting. The drawback with the former is the short range which may be achieved, which has led to a somewhat larger focus on energy harvesting, which may then require an energy storage which may increase the form factor somewhat. With energy harvesting operation, the UE may harvest energy from the environment, e.g., Radio Frequency (RF), vibrational, thermal, etc. until the energy storage, e.g., a super-capacitor, may have a sufficient energy level to perform the intended transmission, e.g., a data report transmission in uplink. During the energy harvesting phase it may be understood to be important to minimize the energy consumption of the device, and therefore the use of a WUR may be understood to be beneficial.

The outcome of the most recent RAN discussion on battery-less IoT, there referred to as ‘Passive IoT’, may be found in RP-212688. Also relevant RAN contributions on the topic may be found in RP-213368, RP-213369, RP-211990, RP-212135, S2-2107084, S1-214144, S1-214134, S1-214149.

In spite of current efforts to improve the usage of energy, existing methods of handling communications in a communications network may result in wasted energy and resources, as well as unnecessary interference.

### SUMMARY

As part of the development of embodiments herein, one or more challenges with the existing technology will first be identified and discussed.

Even with energy harvesting and active transmissions, the uplink coverage for battery-less IoT may most likely not be as good as regular cellular coverage particularly in macro cells. The coverage may be understood to be more “spotty”. In this case, the battery-less and therefore IoT devices may waste energy and resources, and generate unnecessary interference, on triggering uplink transmissions when there may be no uplink coverage, e.g., the transmission may be unsuccessful. In legacy procedure, a UE may first perform cell (re)selection, acquire synchronization and system information, before it may transmit on a cell. This procedure is energy consuming and is not feasible for energy harvesting devices.

It is therefore an object of embodiments herein to improve the handling of a transmission in a wireless communications network.

According to a first aspect of embodiments herein, the object is achieved by a method, performed by a wireless device. The method is for handling a transmission. The wireless device operates in a wireless communications network. The wireless device monitors, in sleep mode, using a first receiver to monitor first radio signals to wake-up the wireless device, whether or not a first radio signal is received from a node. The node operates in the wireless communications network. The first radio signal indicates the wireless device is in coverage of the node. The monitoring is performed with the proviso the wireless device has obtained information to be sent to the node. The first receiver is a WUR. The first radio signal is any signal detectable by the WUR. The wireless device then sends the obtained information to the node. The sending is based on whether or not the wireless device receives the first radio signal during the monitoring. With the proviso the wireless device receives the first radio signal, the first radio signal wakes-up the wireless device from sleep mode. This is performed by waking-up a second receiver to receive signals other than the first radio signals. The wireless device sends the information to the node while the wireless device is in coverage using the second receiver. The wireless device then goes back to sleep mode after the sending, and refrains from performing the monitoring with the proviso the wireless device lacks further information to be sent. With the proviso the wireless device fails to receive the first radio signal, the wireless device stores the information and stays in sleep mode, until the wireless device sends the information, using the second receiver, when the wireless device receives the first radio signal using the first receiver.

According to a second aspect of embodiments herein, the object is achieved by a method, performed by the node. The method is for handling the transmission. The node operates in the wireless communications network. The node sends the first radio signal. The first radio signal indicates the wireless device operating in the wireless communications network, is in coverage of the node. The first radio signal wakes up the wireless device from sleep mode when received by the first receiver used by the wireless device to monitor first radio signals to wake-up the wireless device. The first receiver is a WUR. The first radio signal is any signal detectable by the WUR. The node then receives the information, from the wireless device. The receiving is based on the sent first radio signal. The receiving is from the second receiver to receive signals other than the first radio signals. The second receiver is woken-up at the wireless device by the sent first radio signal.

According to a third aspect of embodiments herein, the object is achieved by the wireless device. The wireless device may be understood to be for handling the transmission. The wireless device is configured to operate in the wireless communications network. The wireless device is further configured monitor, in sleep mode, using the first receiver to monitor first radio signals to wake-up the wireless device, whether or not the first radio signal is received from the node. The node is configured to operate in the wireless communications network. The first radio signal is configured to indicate the wireless device is in coverage of the node. The monitoring is configured to be performed with the proviso the wireless device has obtained the information to be sent to the node. The first receiver is configured to be a WUR. The first radio signal is configured to be any signal configured to be detectable by the WUR. The wireless device is also configured to send the information configured to be obtained to the node. The sending is configured to be based on whether or not the wireless device receives the first radio signal during the monitoring. With the proviso the wireless device receives the first radio signal, the first radio signal is configured to wake-up the wireless device from sleep mode. This is configured to be performed by waking-up the second receiver to receive the signals other than the first radio signals. The wireless device is further configured to a) send the information to the node while the wireless device is in coverage using the second receiver, b) go back to sleep mode after the sending, and c) refrain from performing the monitoring with the proviso the wireless device lacks further information to be sent. With the proviso the wireless device fails to receive the first radio signal, the wireless device is configured to: a) store the information and b) stay in sleep mode, until the wireless device sends the information, using the second receiver, when the wireless device receives the first radio signal using the first receiver.

According to a fourth aspect of embodiments herein, the object is achieved by the node. The node may be understood to be for handling the transmission. The node is configured to operate in the wireless communications network. The node is configured to send the first radio signal. The first radio signal is configured to indicate the wireless device configured to operate in the wireless communications network is in coverage of the node. The first radio signal is configured to wake up the wireless device from sleep mode when received by the first receiver configured to be used by the wireless device to monitor first radio signals to wake-up the wireless device, the first receiver is configured to be a WUR. The first radio signal is configured to be any signal configured to be detectable by the WUR. The node is also configured to receive the information, from the wireless device. The receiving is configured to be based on the first radio signal configured to be sent. The receiving is from the second receiver configured to receive the signals other than the first radio signals. The second receiver is configured to be woken-up at the wireless device by the first radio signal configured to be sent.

By monitoring whether or not the first radio signal is received, the wireless device may be enabled to check whether it may be within coverage of the node before transmitting. Furthermore, the wireless device may further enable to refrain from waking up the second receiver, which may use higher energy than the first receiver, and remain in sleep state, whenever, the wireless device may be out of coverage.

Furthermore, by performing the monitoring in sleep mode using the first receiver, which is a WUR, the wireless device may further enable to, whenever, the wireless device may be out of coverage, refrain from waking up the second receiver, which may use higher energy than the first receiver, and remain in sleep state, thereby saving energy.

Further energy savings may be enabled by the monitoring being performed when the wireless device has obtained the information to be sent to the node.

By the wireless device, sending the obtained information based on whether or not the wireless device receives the first radio signal during the monitoring, the wireless device may be enabled to only send the obtained information when it may be within coverage, thus avoiding unsuccessful UL transmissions. Embodiments herein may be understood to enable to avoid uplink transmission/reporting of the information, and the associated energy and resource waste, when the wireless device may be out of coverage. This may be particularly relevant for examples wherein the wireless device may be operating with energy harvesting, which may otherwise have severe performance degradation.

According to embodiments herein, if the first radio signal is received by the WUR, and only then, may the second receiver be started up to transmit any data in the UL buffer. This may enable the wireless device to have maximal power saving, since in sleep mode, all parts of the wireless device may be shut down except the WUR.

Further energy savings may be enabled by the wireless device going back to sleep after performing the transmission, and refraining from performing the monitoring if the wireless device has no additional information to be sent.

The advantages just described for the wireless device may be enabled by the network node sending the first radio signal, and then receiving the information based on the sent first radio signal.

### BRIEF DESCRIPTION OF THE DRAWINGS

Examples of embodiments herein are described in more detail with reference to the accompanying drawings, according to the following description.

FIG. 1 is a schematic diagram depicting an illustration of a location of a WUS and the paging occasion to which it may be associated.

FIG. 2 is a schematic diagram depicting an illustration of WUS for NB-IoT and LTE-M.

FIG. 3 is a schematic diagram illustrating the use of eDRX and DRX WUS gaps for NB-IoT and LTE-M.

FIG. 4 is a schematic diagram depicting an example of a wireless communications network, according to embodiments herein.

FIG. 5 is a flowchart depicting a method in a wireless device, according to embodiments herein.

FIG. 6 is a flowchart depicting a method in a node, according to embodiments herein.

FIG. 7 is a schematic diagram illustrating a non-limiting agriculture example, according to embodiments herein.

FIG. 8 is a schematic diagram illustrating a non-limiting example of downlink and uplink coverage.

FIG. 9 is a schematic block diagram illustrating two embodiments, in panel a) and panel b), of a wireless device, according to embodiments herein.

FIG. 10 is a schematic block diagram illustrating two embodiments, in panel a) and panel b), of a node, according to embodiments herein.

FIG. 11 is a flowchart depicting a method in a wireless device, according to examples related to embodiments herein.

FIG. 12 is a flowchart depicting a method in a node, according to examples related to embodiments herein.

FIG. 13 is a schematic block diagram illustrating a telecommunication network connected via an intermediate network to a host computer, according to embodiments herein.

FIG. 14 is a generalized block diagram of a host computer communicating via a base station with a user equipment over a partially wireless connection, according to embodiments herein.

FIG. 15 is a flowchart depicting embodiments of a method in a communications system including a host computer, a base station and a user equipment, according to embodiments herein.

FIG. 16 is a flowchart depicting embodiments of a method in a communications system including a host computer, a base station and a user equipment, according to embodiments herein.

FIG. 17 is a flowchart depicting embodiments of a method in a communications system including a host computer, a base station and a user equipment, according to embodiments herein.

FIG. 18 is a flowchart depicting embodiments of a method in a communications system including a host computer, a base station and a user equipment, according to embodiments herein.

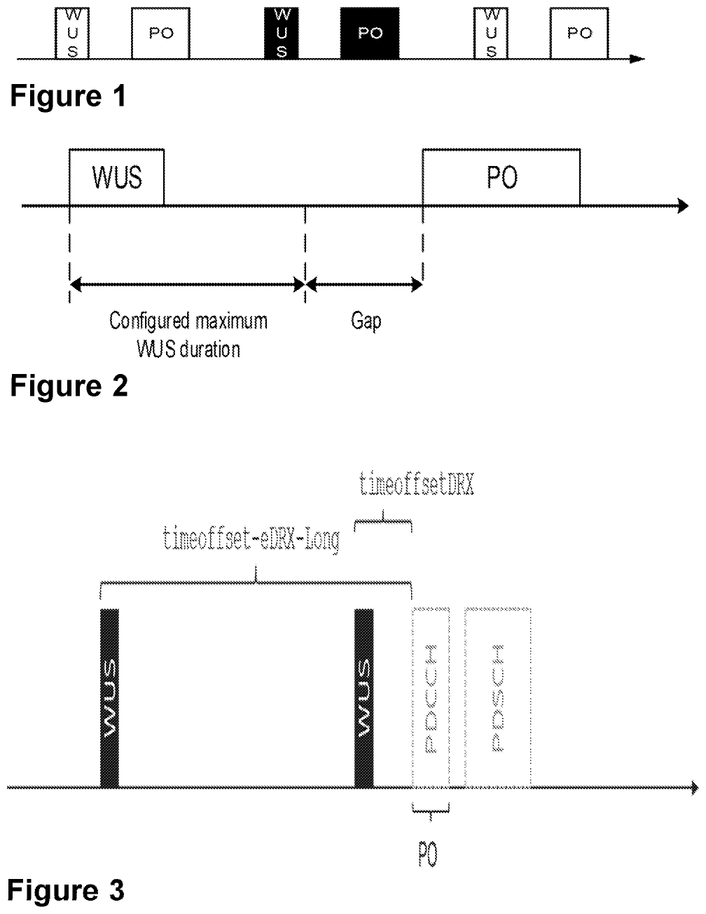

### DETAILED DESCRIPTION

Certain aspects of the present disclosure and their embodiments may provide solutions to the challenges described in the Summary section or other challenges.

Embodiments herein may be generally understood to relate to different aspects of wake-up signal coverage triggered uplink reporting.

In order to achieve a range longer than for competing solutions, such as Radio-frequency identification (RFID), battery-less devices may be understood to most likely rely on energy harvesting and active uplink transmissions. The better supported coverage/range, the more energy may need to be harvested, which may require several hours. It may therefore be understood to not be productive if UEs transmit when there may be no chance of getting the uplink transmission through, that is, when the device may be out of coverage. This may even jeopardize the overall service and performance of the device, since there may be no guarantee that the device will most often be out of coverage when enough energy has been harvested to be able to transmit in the uplink.

The simplest way to remedy this may be that the UE may check whether it is within coverage before transmitting, thus avoiding unsuccessful UL transmissions. In legacy, this may be said to be captured by the Idle mode procedures and the initial access, that is, the UE may perform cell selection or re-selection to find a suitable cell to camp on, which may periodically require the UE to perform Radio Resource Management (RRM) measurements and acquire system information of cells in the vicinity. If it may be relatively common that the UE is out coverage, e.g., battery-less IoT devices may in some scenarios be in coverage only rarely, such a procedure is sub-optimal and may cause unnecessary energy consumption.

Embodiments herein may be understood enable to avoid energy waste from the UE attempting UL transmissions when it may be out-of-coverage. That is, the UE may reside in a sleep state and only when the UE may enter an area with coverage, a periodically broadcasted WUS may inform the UE that it is now in coverage and may trigger an uplink transmission.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

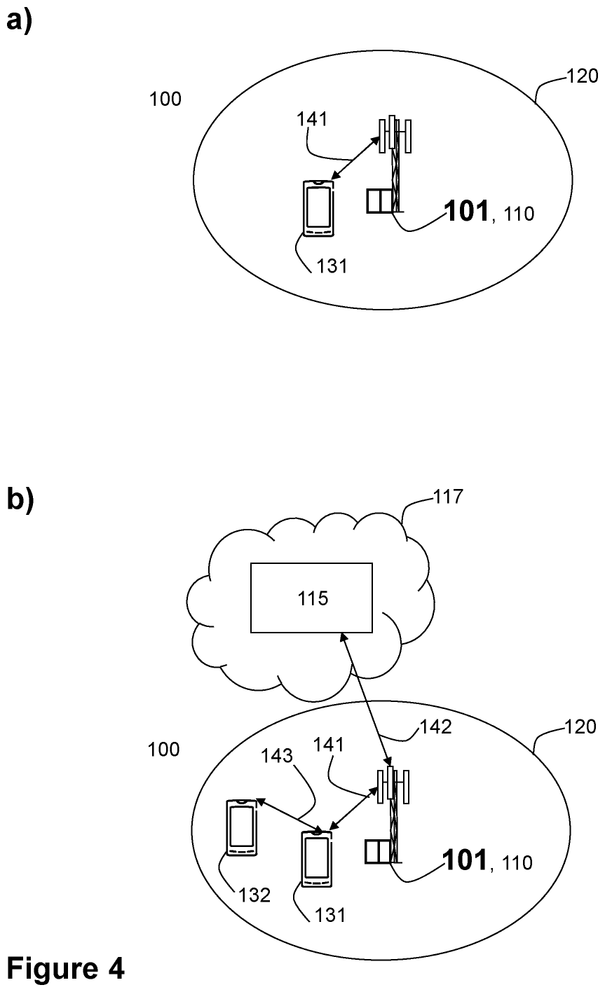

FIG. 4 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network, or a posterior system with similar functionality. In other examples, the wireless communications network 100 may instead, or in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced eLAA (eLAA), further enhanced LAA (feLAA) and/or MulteFire. The wireless communications network 100 may typically be support MTC, enhanced Machine Type Communication (eMTC), IoT and/or NB-IoT. Yet in other examples, the wireless communications network 100 may support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of nodes, whereof a node 101 is depicted in the non-limiting examples of FIG. 4. The node 101 may be a network node, such as the network node 110 described below. This corresponds to the non-limiting examples depicted in FIG. 4. In some embodiments, the node 101 may be a core network node such as the core network node 115 described below. Yet in other embodiments, the node 101 may be a wireless device, such as the second wireless device 132 described below.

The wireless communications network 100 may comprise a plurality of network nodes, whereof a network node 110 is depicted in the non-limiting example of FIG. 4. The network node 110 may be a radio network node. That is, a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, such as that depicted in FIG. 4b, the network node 110 may be a distributed node, and may partially perform its functions in collaboration with a virtual node in a cloud 117.

The wireless communications network 100 may cover a geographical area, which in some embodiments may be divided into cell areas, wherein each cell area may be served by a radio network node, although, one radio network node may serve one or several cells. In the example of FIG. 4, the network node 110 serves a cell 120. The network node 110 may be of different classes, such as, e.g., macro eNodeB, home eNodeB or pico base station, based on transmission power and thereby also cell size. In some examples, the network node 110 may serve receiving nodes with serving beams. The radio network node may support one or several communication technologies, and its name may depend on the technology and terminology used. Any of the radio network nodes that may be comprised in the communications network 100 may be directly connected to one or more core networks. The one or more core networks may comprise a core networks may comprise a core network node 115, as depicted in the non-limiting example of FIG. 4b. The core network node 115 may communicate with the wireless device 131 directly, or via the network node 110.

A plurality of wireless devices may be located in the wireless communication network 100, whereof a wireless device 131, which may be also referred to herein as a first wireless device 131, is depicted in the non-limiting examples of FIG. 4. In some embodiments, as in the non-limiting example depicted in FIG. 4 b), the wireless communications network 100 may comprise another wireless device 132, which may be also referred to herein as a second wireless device 132. Any of the wireless device 131 and the another wireless device 132 comprised in the wireless communications network 100 may be a wireless communication device such as a 5G UE, or a UE, which may also be known as e.g., mobile terminal, wireless terminal and/or mobile station, a mobile telephone, cellular telephone, laptop with wireless capability, a sensor, or an IoT device, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. Any of the wireless device 131 and the another wireless device 132 comprised in the wireless communications network 100 may be enabled to communicate wirelessly in the wireless communications network 100. The communication may be performed e.g., via a RAN, and possibly the one or more core networks, which may be comprised within the wireless communications network 100.

The node 101 may be configured to communicate within the wireless communications network 100 with the wireless device 131 over a first link 141, e.g., a radio link. The network node 110 may be configured to communicate within the wireless communications network 100 with the core network node 115 over a second link 142, e.g., a radio link or a wired link. The wireless device 131 may be configured to communicate within the wireless communications network 100 with the second wireless device 132 over a third link 143, e.g., a radio link or a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first” and/or “second” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 131, e.g., a 5G UE or a UE, and embodiments related to a node, such as the network node 110, e.g., a gNB or an eNB.

Some embodiments herein will now be further described with some non-limiting examples.

In the following description, any reference to a/the UE, or simply “UE” may be understood to equally refer to the wireless device 131; any reference to a/the gNB, a/the “base-station”, or a/the “network” may be understood to equally refer to the node 101; any reference to a/the C-WUS(s) may be understood to equally refer to the first radio signal.

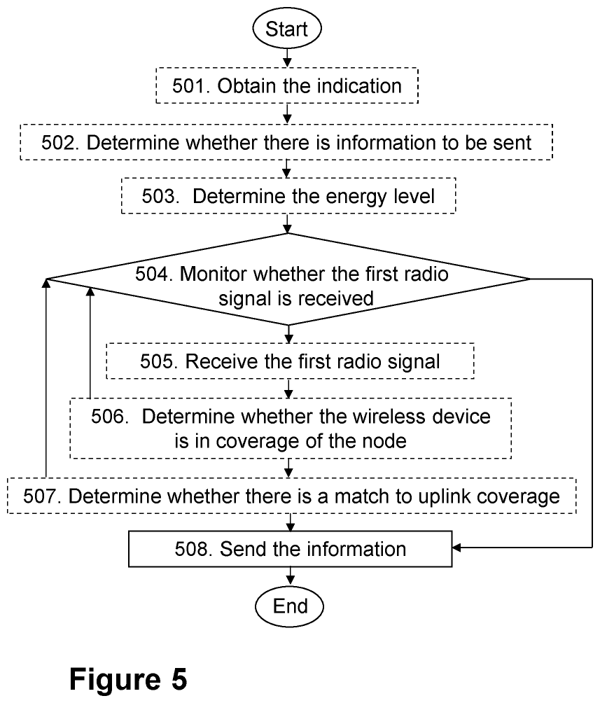

Embodiments of a method, performed by a wireless device, such as the wireless device 131, will now be described with reference to the flowchart depicted in FIG. 5. The method is for handling a transmission. The wireless device 131 operates in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

In some embodiments, the wireless communications network 100 may be a 5G network.

In some embodiments, the wireless device 131 may be a battery-less device. The node may be one of: the network node 110, the core network node 115, and the another wireless device 132.

Several embodiments are comprised herein. The method may comprise two or more of the following actions. In some embodiments, all the actions may be performed. In other embodiments, some of the actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 131 is depicted in FIG. 5. In some examples, the actions may be performed in a different order than that depicted in FIG. 5. For example, Action 502 may be performed after Action 506. In FIG. 5, optional actions in some embodiments may be represented with dashed lines.

### Action 501

In this Action 501, the wireless device 131 may obtain an indication. The indication may comprise a first configuration indicating how the wireless device 131 is to perform a monitoring, as will be described in Action 504. The monitoring may be of whether or not a first radio signal may be received from the node 101 operating in the wireless communications network 100. The first radio signal indicates the wireless device 131 is in coverage of the node 101. The monitoring may be performed while the wireless device 131 may be in sleep mode. The first radio signal may be understood to wake up the wireless device 131 from sleep mode. The wireless device 131 may reside in sleep mode until the first radio signal wakes up the wireless device 131 from sleep mode. To be in sleep mode may enable the wireless device 131 to save energy and e.g., in some examples, e.g., when the wireless device 131 may be a battery-less IoT device, to harvest energy.

The monitoring may be performed using a first receiver to monitor first radio signals to wake-up the wireless device 131. The first receiver may be a WUR. The WUR may be understood to have very low energy consumption. For example, the WUR may need to have significantly lower complexity and power consumption than a second receiver, e.g., the main receiver, also referred to herein as baseband receiver or main radio. The WUR may be understood as e.g., a low-power receiver which may not be able to receive legacy PHY-channels PDSCH, PDCCH, etc. As in some existing methods, the WUR may enable the base-station, such as the node 101 in some embodiments, to transmit a wake-up signal (WUS) to the wireless device 131 for downlink reachability and data transmission.

According to embodiments herein, base-stations such as the node 101 in some embodiments, may periodically broadcast a common WUS to UEs such as the wireless device 131, to indicate to them that they are in coverage. This common WUS may be here referred to as ‘Coverage WUS’ or C-WUS. Any base-station, such as the node 101 in some embodiments, supporting battery-less IoT devices may there in this case broadcast the C-WUS. The first radio signal may be, in some examples, be referred to herein as a C-WUS. In some examples of embodiments herein, the first radio signal, e.g., the C-WUS, may be a specific signal, e.g., a code sequence, dedicated for the purpose.

The first radio signal is any signal detectable by the WUR, e.g., WUR-SSB, C-WUS. The first radio signal, when received by the wireless device 131, may wake-up the wireless device 131 from sleep mode by waking-up the second receiver to receive signals other than the first radio signals. The signals other than the first radio signals that may be received by the second receiver may be, e.g., to page the wireless device 131. In sleep mode, all parts of the wireless device 131 may be shut down except the WUR. This may enable the wireless device 131 to have maximal power saving.

The monitoring may have to be performed with the proviso the wireless device 131 may have obtained information to be sent to the node 101.

Obtaining may be, e.g., receiving from the network node 110, e.g., from the node 101, e.g., the node 101 being the network node 110 or another node, or retrieving from a memory.

In some embodiments, at least one of the following may apply. According to a first option, the first radio signal may wake up the wireless device 131 from sleep mode and it may be different than a second radio signal. The second radio signal may wake up the wireless device 131 for downlink reachability. For example, the second radio signal may be a WUS, e.g., for paging, whereas the first radio signal may be a C-WUS. In other words, in some examples, the first radio signal may wake-up the wireless device 131 but not to detect an incoming message, e.g., a paging message. When the wireless device 131 may move into coverage, the first radio signal, e.g., a periodic C-WUS, may trigger the wireless device 131 to check if there may be UL data transmit, in agreement with Action 502 described later, and if there is data, transmission may be initiated, as will be described later in Action 508.

According to a second option, the first radio signal may be periodically transmitted. If the wireless device 131 is in coverage of the node 101 and monitoring the first radio signal may be periodically received, by the wireless device 131. As stated earlier, the node 101, e.g., the network node 110, may periodically broadcast a common WUS to UEs such as the wireless device 131, to indicate to them that they are in coverage.

According to a third option, the first radio signal may be one of: cell specific and network specific, e.g., common in the entire network. In other examples of embodiments herein, any other common, e.g., cell specific or network specific, signal which may be detected using a WUR may repurposed to be used as the first radio signal, e.g., C-WUS. For example, a WUR synchronization signal, a WUR-SSB, similar to legacy SSB content and purpose, a WUR-System Information (SI) broadcast, etc.

In specific embodiments, according to a fourth option, the first radio signal may be a WUR-SSB.

According to a fifth option, the first radio signal may be coordinated with paging occasions (POs) used with signals to wake-up the wireless device 131, and the first radio signal may be one of the signals to wake-up the wireless device 131. In some examples of embodiments herein, the broadcast of the C-WUS may be coordinated with POs used for WUS in the cell 120, such that no addition wake-up from the sleep state may be required for a given UE such as the wireless device 131. For example, if 4 POs are configured in the cell 120 per System Frame Number (SFN) cycle, C-WUS may be transmitted in all of them to ensure any UE in the cell 120 may be reached, e.g., UEs may be distributed over the 4 different POs, and a given UE may only monitor paging and WUS in one of them. See e.g., 3GPP TS 38.304, v. 16.7.0 for details.

In an alternative embodiment of the above, the C-WUS occasions may be adjacent to the POs, to minimize the time the UE may have to stay out of the sleep state, but in non-overlapping time- and frequency-resources the UE may use to receive both WUS for paging and C-WUS. According to a sixth option, the first radio signal may be coordinated with paging occasions used with signals to wake-up the wireless device 131, and the first radio signal may be different from and non-overlapping with the signals to wake-up the wireless device 131. The signals to wake-up the wireless device 131 may be WUS for paging, and e.g., the first radio signal may be C-WUS.

According to a seventh option, the signals to wake-up the wireless device 131 and the first radio signal may be jointly encoded. In some examples of embodiments herein, the C-WUS and the WUS for paging may be jointly encoded. For example, C-WUS may be a base version of a signal transmitted in every PO, but an alteration of the signal may mean that the wireless device 131 in this PO, in addition, may need to wake up to monitor paging, e.g., according to legacy WUS/WUR procedure. The alteration may be a modification, or a different, code sequence, transmission in a different frequency- or time-resource, or if WUS may carry a payload, a bit set separately in the data payload, e.g., a flag. An example of the latter may be the broadcast of a WUR-SSB, e.g., synchronization and system information needed for the WUR operation in a cell, such as the cell 120. A data field may indicate if UEs may need to, in addition, wake-up or continue to monitor paging. UE multiplexing may be achieved by distributing UEs over several POs, e.g., ‘quasi-random’ based on UE_ID, or the data field may use multiple bits to indicate which paging groups may be being paged, again, possibly distributed “uniformly” based on UE_ID.

According to an eighth option, at least one of a periodicity and a second configuration of the first radio signal may change over time based on one or more conditions. In some examples of embodiments herein, the periodicity/configuration, that is, the second configuration, of the first radio signal, e.g., C-WUS, may change over time depending on various factors such as mobility pattern, coverage condition, and energy availability. For example, the first radio signal, e.g., C-WUS, may need to be used more frequently for moving devices while less frequently for stationary devices. The one or more conditions may be, e.g., a particular mobility pattern, a particular coverage condition, a particular level of energy availability, etc.

According to a ninth option, the periodicity of the first radio signal may be linked to an operation mode of the WUR. In some examples of embodiments herein, the periodicity of the first radio signal, e.g., the C-WUS periodicity, may be linked to the WUR operation mode. In general, WUR operation may be continuous, that is, always on, or duty-cycled, that is, periodically on and off. In case a duty-cycled WUR is employed to monitor the first radio signal, e.g., C-WUS, the periodicity of C-WUS may depend on the WUR DRX cycle.

According to an eleventh option, coverage enhancement may be used to monitor the first radio signal. Since WUR may need to have significantly lower complexity and power consumption than the main receiver, its sensitivity/coverage may be slightly lower than the main radio. In such a scenario, even if the wireless device 131 is in the coverage, the WUR may not detect the first radio signal, e.g., C-WUS, and thus it may not wake up the main radio. One way to alleviate this situation may be to consider coverage enhancements for the first radio signal, e.g., C-WUS. For instance, C-WUS repetition or power boosting may be applied for coverage enhancement. This may reduce the miss detection probability for WUR operation.

By obtaining the indication in this Action 501, the wireless device 131 may then be enabled to know how the wireless device 131 may need to perform a monitoring, as will be described in Action 504.

### Action 502

In some examples of embodiments herein, monitoring for the first radio signal, e.g., C-WUS, may be enabled only when the uplink data buffer may not be empty.

In this Action 502, the wireless device 131 may determine whether or not there may be any information to be sent. Information may be data. For example, the wireless device 131 may check if there may be uplink data in the buffer to transmit.

Determining in this Action 502 may comprise deciding, calculating or checking.

The determining in this Action 502 may be of whether or not there may be any information to be sent in the uplink.

By, in this Action 502, determining whether or not there may be any information to be sent, the wireless device 131 may be enabled to only perform the monitoring of the first radio signal when it may need to send the information, and refrain from monitoring otherwise. This may enable the wireless device 131 to continue to save energy, which, in the event for example, the wireless device 131 may be a battery-less IoT device, may be particularly relevant.

### Action 503

In this Action 503, the wireless device 131 may determine an energy level of the wireless device 131, e.g., the battery level of the wireless device 131.

In other examples of embodiments herein, monitoring for the first radio signal, e.g., C-WUS, may be enabled based on the UE battery level and energy harvesting pattern. For example, if for a period of time the wireless device 131 has sufficient battery and may have access to relatively sustainable energy source, e.g., sufficient energy harvesting, then the first radio signal, e.g., C-WUS, may not be necessary. Otherwise, if the battery level is below a certain threshold, the first radio signal, e.g., C-WUS, may be employed for power saving.

By determining the energy level of the wireless device 131 in this Action 503, the wireless device 131 may therefore be enabled to achieve such power saving.

### Action 504

In this Action 504, the wireless device 131 monitors, in sleep mode, using the first receiver to monitor the first radio signals to wake-up the wireless device 131, whether or not the first radio signal is received.

Monitoring in this Action 504 may comprise measuring or checking.

The monitoring is of whether or not the first radio signal is received from the node 101 operating in the wireless communications network 100.

The first radio signal indicates the wireless device 131 is in coverage of the node 101.

The monitoring in this Action 504 is performed with the proviso the wireless device 131 has obtained information to be sent, e.g., uplink, to the node 101. The wireless device 131 may refrain from performing the monitoring 504 otherwise. That is, in the absence of having obtained information to be sent, e.g., uplink, to the node 101. This may be understood to be determined in Action 502.

The first radio signal is any signal detectable by the WUR, and the first receiver is the WUR. The first radio signal, when received by the wireless device 131, wakes-up the wireless device 131 from sleep mode by waking-up the second receiver to receive signals other than the first radio signals. The second receiver may remain in a power saving state during the monitoring in this Action 504. According to a first group of examples of embodiments herein, the wireless device 131, e.g., a battery-less IoT device, may be using the WUR to monitor for downlink transmissions while the main radio may be in a power saving state to harvest energy.

The monitoring in this Action 505 may be performed based on the indicated first configuration. In some examples of embodiments herein, it may be configured by the node 101 in which radio resources and with which periodicity the wireless device 131 may need to monitor for C-WUS, which may or may not be the same as the monitoring for paging, see above.

The monitoring in Action 504 may be performed with the proviso the wireless device 130 may determine that the information has been obtained, e.g., and may refrain from performing the monitoring in Action 504 otherwise.

The monitoring in this Action 504 may be performed with the proviso the determined energy level may exceed a first threshold.

By monitoring whether or not the first radio signal is received in this Action 204, the wireless device 131 may be enabled to check whether it may be within coverage of the node 101 before transmitting, thus avoiding unsuccessful UL transmissions. Embodiments herein may be understood to enable to avoid uplink transmission/reporting of the information, and the associated energy and resource waste, when the wireless device 131 may be out of coverage. This may be particularly relevant for examples wherein the wireless device 131 may be operating with energy harvesting, which may otherwise have severe performance degradation.

Furthermore, by performing the monitoring in sleep mode using the first receiver, which is a WUR, the wireless device 131 may further enable to, whenever, the wireless device 131 may be out of coverage, refrain from waking up the second receiver, which may use higher energy than the first receiver, and remain in sleep state, thereby saving energy.

Further energy savings may be enabled by the monitoring 504 being performed when the wireless device 131 has obtained the information to be sent to the node.

### Action 505

As stated earlier, since the WUR may need to have significantly lower complexity and power consumption than the main receiver, its sensitivity/coverage may be slightly lower than the main radio. In such a scenario, even if the wireless device 131 may be in the coverage, the WUR may not detect the first radio signal, e.g., C-WUS, and thus it may not wake up the main radio. In other words, event if the first radio signal may be transmitted, the wireless device 131 may not always detect it, or receive it.

In this Action 505, the wireless device 131 may receive the monitored first radio signal.

### Action 506

In this Action 506, the wireless device 131 may determine whether or not the wireless device 131 is in coverage.

The determining in this Action 506 may be based on whether or not the wireless device 131 may receive the first radio signal from the node 101, e.g., based on the first radio signal having a strength above a second threshold.

In some examples of embodiments herein, the measured signal strength or signal quality, e.g., Reference Signal Received Power (RSRP) or Reference Signal Received Quality (RSRQ) of the first radio signal, e.g., C-WUS, may have to be above a defined threshold for the UE to consider itself to be ‘in coverage’. The threshold may either be hard-coded in specification or semi-statically preconfigured, e.g., in system information. For example, this threshold may be configured in the first configuration.

In some examples of embodiments herein, WUS may not be used, but any other, e.g., legacy, downlink signal may be used. For example, if the wireless device 131 may wake up and not measure any SSB to be above a pre-determined threshold, e.g., configured by the network, the wireless device 131 may consider itself ‘out of coverage’, go back to a sleep state and refrain from initiating transmission of the data in its uplink buffer until the ‘in coverage’ conditions may be fulfilled.

In some examples, Action 502 may be performed after this Action 506. For example, when the wireless device 131 may move into coverage, the first radio signal, e.g., a periodic C-WUS, may trigger the wireless device 131 to check if there may be UL data transmit, and if there is data, transmission may be initiated, as will be described later, in Action 508.

### Action 507

In this Action 507, the wireless device 131 may determine whether or not the coverage of the node 101 matches an uplink coverage. The uplink coverage may be of, e.g., uplink, transmission of the wireless device 131.

Due to the different physical channel design, different transmit power, different radio channel, etc. it may be in practice not the case that uplink and downlink coverage may be reciprocal. Therefore, it may need to be ensured that the downlink coverage of the first radio signal, e.g., C-WUS, matches the coverage of the uplink transmission of the wireless device 131, e.g., the UE's uplink transmission, or otherwise determined if uplink coverage may be sufficient. This may be achieved in various ways, as described next.

A first way may be by common UE power class and up to network implementation. For example, all Zero Energy (ZE)/Passive IoT UEs may support the same UE power class, and the node 101, e.g., the network node 110 may adapt the output power, and/or the design, e.g., the sequence length, of the first radio signal, C-WUS, to match the expected uplink coverage of UEs such as the wireless device 131. For the wireless device 131, this may mean that if it is woken up by the first radio signal, it may need to consider uplink coverage to be sufficient without any further check. Possibly there may be a back-off in the power of the first radio signal to achieve somewhat worse downlink coverage to ensure that all UEs may have uplink coverage, that is, as a “safety precaution”. It may be noted that, in this case, the maximum output power of UEs may always be the same. For example, the node 101, e.g., the network node 110, may adapt the first radio signal, C-WUS, power depending on the cell 120 size, but without any further check in the wireless device 131, see the next paragraph, UEs may always consider the same maximum output power and there may be no way to configure a reduced uplink power in small cells, such as in legacy LTE or NR. It may be noted, however, that the uplink coverage of ZE/Passive IoT may typically be very limited and that this in practice therefore may not be a problem.

A second way may be by the first radio signal, C-WUS, triggering further check by the wireless device 131. In this example of embodiments herein, the first radio signal, C-WUS, may wake the wireless device 131, informing the wireless device 131 that is it is in “DL coverage”, but the wireless device 131 may have to perform a further check to see, in this Action 507, if it is in “UL coverage” and if uplink coverage may be expected to be good enough to initiate uplink transmission. See FIG. 8. For example, the first radio signal, C-WUS, may wake up the wireless device 131 to perform the check to see if it may also be in UL coverage, where the later check may take cell- and WUS-configuration of system information and the power class of the wireless device 131, etc. into account. Note that this check may be similar to the legacy cell (re-)selection criteria of LTE and NR, see e.g., section 5.2.3.2 of 3GPP TS 38.304, v. 16.7.0. Therefore, this alternative may be understood to be more flexible and may work better if different UE types and cell sizes are to be supported. The drawback may be understood to be that whenever the wireless device 131 may be woken up by the first radio signal, e.g., C-WUS, some additional UE activity and processing may be required compared to the first alternative described in the previous paragraph, which may not be desirable for energy harvesting operation. Note that in both examples, the first way and the second way, the periodicity of this may be controlled by the periodicity of the first radio signal, which may therefore determine the trade-off between energy consumption by the wireless device 131, and uplink data reporting latency.

### Action 508

In this Action 508, the wireless device 131 sends, that is, transmits, the obtained information to the node 101, e.g., in the uplink. The sending in this Action 508 is based on whether or not the wireless device 131 receives the first radio signal during the monitoring in Action 504.

With the proviso the wireless device 131 receives the first radio signal, the first radio signal wakes-up the wireless device 131 from sleep mode by waking-up the second receiver to receive the signals other than the first radio signals and the wireless device 131: a) sends the information to the node 101 while the wireless device 131 is in coverage using the second receiver, b) goes back to sleep mode after the sending 508, and c) refrains from performing the monitoring 504 with the proviso the wireless device 131 lacks further information to be sent, e.g., in the uplink.

With the proviso the wireless device 131 fails to receive the first radio signal, that is, during the monitoring 504, the wireless device 131: a) stores the information and b) stays in sleep mode, until the wireless device 131 sends the information, in this Action 508, using the second receiver, when the wireless device 131 receives the first radio signal using the first receiver.

Accordingly, the sending in Action 508 may be understood to be based on the received first radio signal.

The sending in this Action 508 of the information may be: i) performed only after the determination performed in Action 506 and ii) based on a result of the determination performed in Action 506. The wireless device 131, e.g., any battery-less IoT UE, may buffer all uplink data until it may be woken up by the first radio signal. As a consequence, uplink transmissions may be delayed until the wireless device 131 may be in coverage. When the wireless device 131 is in coverage, the wireless device 131 may periodically be woken up by the first radio signal, but since WUR may be understood to have very low energy consumption, and the wireless device 131 may anyway need to check if it is being paged, the additional overhead may be understood to then be only the logical check in the wireless device 131 if there may be uplink data in the buffer to transmit, which may be understood to be acceptable, especially with a reasonably long the first radio signal periodicity.

The sending in this Action 508 of the information may be performed with the proviso the match may have been determined in Action 507.

In some embodiments, the wireless device 131 may uses the first receiver to monitor first radio signals to wake-up the wireless device 131 and the second receiver to receive signals other than the first radio signals.

In some embodiments, the sending in this Action 508 of the information may be performed in the absence of performing cell selection and/or cell reselection.

By the wireless device 131 sending the information in this Action the sending in this Action 508 in the absence of performing cell selection and/or cell reselection, the first device 131 may avoid causing unnecessary energy consumption, in comparison, for example to the idle mode procedures and the initial access in legacy, which may periodically require a UE to perform RRM measurements and acquire system information of cells in the vicinity.

By the wireless device 131, in this Action 508, sending the obtained information based on whether or not the wireless device 131 receives the first radio signal during the monitoring in Action 504, the wireless device 131 may be enabled to only send the obtained information when it may be within coverage, thus avoiding unsuccessful UL transmissions. Embodiments herein may be understood to enable to avoid uplink transmission/reporting of the information, and the associated energy and resource waste, when the wireless device 131 may be out of coverage. This may be particularly relevant for examples wherein the wireless device 131 may be operating with energy harvesting, which may otherwise have severe performance degradation.

Furthermore, the wireless device 131 may further enable to refrain from waking up the second receiver, which may use higher energy than the first receiver, and remain in sleep state, whenever, the wireless device 131 may be out of coverage.

According to embodiments herein, if the first radio signal is received by the WUR, and only then, may the main receiver be started up to transmit any data in the UL buffer. This may enable the wireless device 131 to have maximal power saving, since in sleep mode, all parts of the wireless device 131 may be shut down except the WUR.

Further energy savings may be enabled by the wireless device 131 going back to sleep after performing the transmission, and refraining from performing the monitoring 508 if the wireless device 131 has no additional information to be sent.

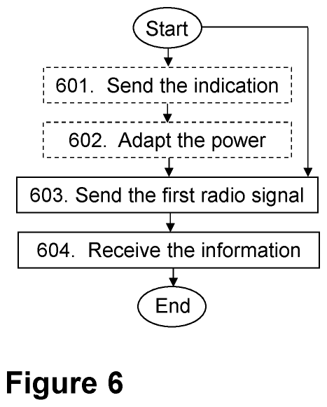

Embodiments of a method, performed by a node, such as the node 101, will now be described with reference to the flowchart depicted in FIG. 6. The method is for handling the transmission. The node 101 operates in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

In some embodiments, the wireless communications network 100 may be a 5G network.

Several embodiments are comprised herein. In some embodiments, all the actions may be performed. In other embodiments, some of the actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the node 101 is depicted in FIG. 6. In FIG. 6, optional actions in some embodiments are represented with dashed lines.

The detailed description of some of the following corresponds to the same references provided above, in relation to the actions described for the wireless device 131 and will thus not be repeated here to simplify the description. For example, the first radio signal may be referred to herein as, e.g., a C-WUS.

### Action 601

In this Action 601, the node 101 may send the indication to the wireless device 131. The indication may comprise the first configuration indicating how the wireless device 131 may have to monitor the first radio signal.

In some embodiments, the wireless device 131 may be a battery-less device. The node may be one of: the network node 110, the core network node 115, and the another wireless device 132.

This Action 601 may be performed in embodiments wherein e.g., the node 101 may be the network node 110.

The sending in this Action 602 may be performed, e.g., via the first link 141.

### Action 602

As explained earlier, it may be in practice not the case that uplink and downlink coverage may be reciprocal. Therefore, it may need to be ensured that the downlink coverage of the first radio signal, e.g., C-WUS, matches the coverage of the uplink transmission of the wireless device 131, e.g., the UE's uplink transmission.

In some embodiments, in this Action 602, the node 101 may adapt a power of transmission of the first radio signal.

The first radio signal may be transmitted with the adapted power.

By the node 101 adapting the power of transmission in this Action 602, the node 101 may then be enabled to match the expected uplink coverage of the wireless device 131. For the wireless device 131, this may mean that if it is woken up by the first radio signal, it may need to consider uplink coverage to be sufficient without any further check.

### Action 603

In this Action 603, the node 101 sends, that is, transmits, the first radio signal.

The first radio signal indicates the wireless device 131 operating in the wireless communications network 100 is in coverage of the node 101.

The first radio signal wakes up the wireless device 131 from sleep mode when received by the first receiver used by the wireless device 131 to monitor the first radio signals to wake-up the wireless device 131. The first receiver is a WUR. The first radio signal is any signal detectable by the WUR.

The sending in this Action 603 may be performed, e.g., via the first link 141.

In some embodiments, at least one of the following may apply: a) the first radio signal may wake up the wireless device 131 from sleep mode and it may be different than the second radio signal, wherein the second radio signal may wake up the wireless device 131 for downlink reachability; b) the first radio signal may be periodically sent, that is, transmitted, c) the first radio signal may be one of: cell specific and network specific, d) the first radio signal may be a WUR-SSB, e) the first radio signal may be coordinated with paging occasions used with signals to wake-up the wireless device 131, and the first radio signal may be one of the signals to wake-up the wireless device 131, f) the first radio signal may be coordinated with paging occasions used with signals to wake-up the wireless device 131, and the first radio signal may be different from and non-overlapping with the signals to wake-up the wireless device 131, g) the signals to wake-up the wireless device 131 and the first radio signal may be jointly encoded, h) at least one of the periodicity and the second configuration of the first radio signal may change over time based on the one or more conditions; and i) the periodicity of the first radio signal may be linked to an operation mode of the WUR.

By the node 101 sending the first radio signal in this Action 603, the node 101 may then enable the wireless device 131 to achieve the advantages described earlier for the wireless device 131, e.g., in relation to Action 504 and Action 508.

### Action 604

In this Action 604, the node 101 receives the information, e.g., in the uplink, from the wireless device 131. The receiving in this Action 604 is based on the sent first radio signal. The receiving in this Action 604 is from the second receiver to receive signals other than the first radio signals, woken-up at the wireless device 131 by the sent first radio signal

The receiving in this Action 604 may be based on the indicated first configuration.

The receiving in Action 604 may be based on the adapted transmitted first radio signal.

In some embodiments, at least one of the following may apply: a) the first radio signal may wake up the wireless device 131 from sleep mode and it may be different than the second radio signal, wherein the second radio signal may wake up the wireless device 131 for downlink reachability; b) the first radio signal may be periodically sent, that is, transmitted, c) the first radio signal may be one of: cell specific and network specific, d) the first radio signal may be a WUR-SSB, e) the first radio signal may be coordinated with paging occasions used with signals to wake-up the wireless device 131, and the first radio signal may be one of the signals to wake-up the wireless device 131, f) the first radio signal may be coordinated with paging occasions used with signals to wake-up the wireless device 131, and the first radio signal may be different from and non-overlapping with the signals to wake-up the wireless device 131, g) the signals to wake-up the wireless device 131 and the first radio signal may be jointly encoded, h) at least one of the periodicity and the second configuration of the first radio signal may change over time based on the one or more conditions; i) the receiving in Action 604 of the information may be performed in the absence of performing cell selection and/or cell reselection, and j) the periodicity of the first radio signal may be linked to an operation mode of the WUR.

By the node 101 receiving the information based on the sent first radio signal in this Action 604, the node 101 may then enable the wireless device 131 to achieve the advantages described earlier for the wireless device 131, e.g., in relation to Action 508.

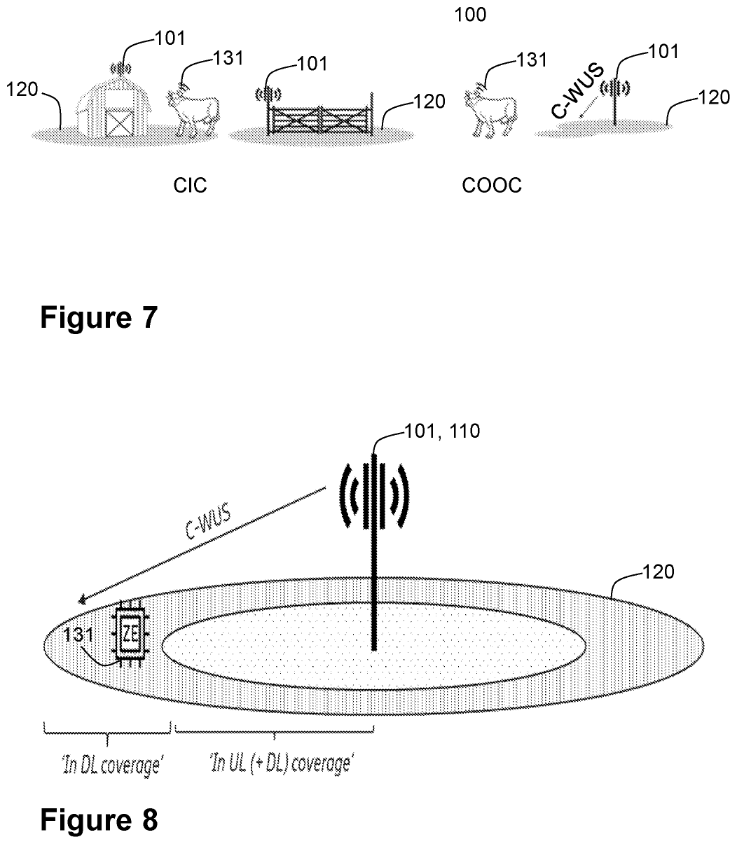

One example of an outdoor scenario wherein embodiments herein may be implemented may be the agriculture use case brought up for Passive IoT. That is, keeping track of livestock, e.g., location, status reporting, etc. FIG. 7 is a schematic diagram illustrating a non-limiting agriculture example, according to embodiments herein. As shown in FIG. 7, outdoor coverage may not be complete and restricted to areas close to barns, gates and base-stations, namely the nodes 101, coverage may be uplink limited. In the non-limiting example depicted in FIG. 7, each of the nodes 101 is a network node 110, each covering one or more cells, such as cell 120. The wireless device 131 is, in this example, a battery-less IoT device attached to a cow. Battery-less IoT devices may measure data of the cattle, e.g., the position, mobility, temperature, etc., but only store the information in the UL data buffer as long as the wireless device 131 may be out of coverage. This is indicated by the cow on the right side, which is a cow out of coverage (COOC). The wireless device 131 may otherwise be in a sleep mode to harvest energy, e.g., from vibrations in this case, but with a WUR to monitor incoming downlink transmissions. When an animal and its wireless device 131 may move into coverage, the first radio signal, a periodic C-WUS, monitored according to Action 504 and received according to Action 505, may trigger the wireless device 131 to check if there may be UL data transmit, in accordance with Action 502, and if there is data, transmission may be initiated, in accordance with Action 508. This is indicated by the cow on the left side, which is a cow in coverage (CIC).

FIG. 8 is a schematic diagram illustrating a non-limiting example of downlink and uplink coverage. In this non-limiting example, the node 101 is a network node 110, and the wireless device 131 is a ZE/Passive IoT UE. As depicted in FIG. 8, the first radio signal, C-WUS, may wake the wireless device 131, informing the wireless device 131 that is it is in “DL coverage”, but the wireless device 131 may have to perform a further check, according to Action 507, to see if it is in “UL coverage” and if uplink coverage may be expected to be good enough to initiate uplink transmission. For example, the first radio signal, C-WUS, may wake up the wireless device 131 to perform the check to see if it may also be in UL coverage, where the later check may take cell- and WUS-configuration of system information and the power class of the wireless device 131, etc. into account. Note that this check may be similar to the legacy cell (re-)selection criteria of LTE and NR, see e.g., section 5.2.3.2 of 3GPP TS 38.304, v. 16.7.0. Therefore, this alternative may be understood to be more flexible and may work better if different UE types and cell sizes are to be supported. The drawback may be understood to be that whenever the wireless device 131 may be woken up by the first radio signal, e.g., C-WUS, some additional UE activity and processing may be required compared to the first alternative described in the previous paragraph, which may not be desirable for energy harvesting operation. The periodicity off this may be controlled by the periodicity of the first radio signal, which may therefore determine the trade-off between energy consumption by the wireless device 131, and uplink data reporting latency.

Certain embodiments disclosed herein may provide one or more of the following technical advantage(s), which may be summarized as follows. Embodiments herein may be understood to enable to avoid uplink transmission/reporting, and the associated energy and resource waste, when UEs may be out of coverage, mainly for UE's operating with energy harvesting, which may otherwise have severe performance degradation.

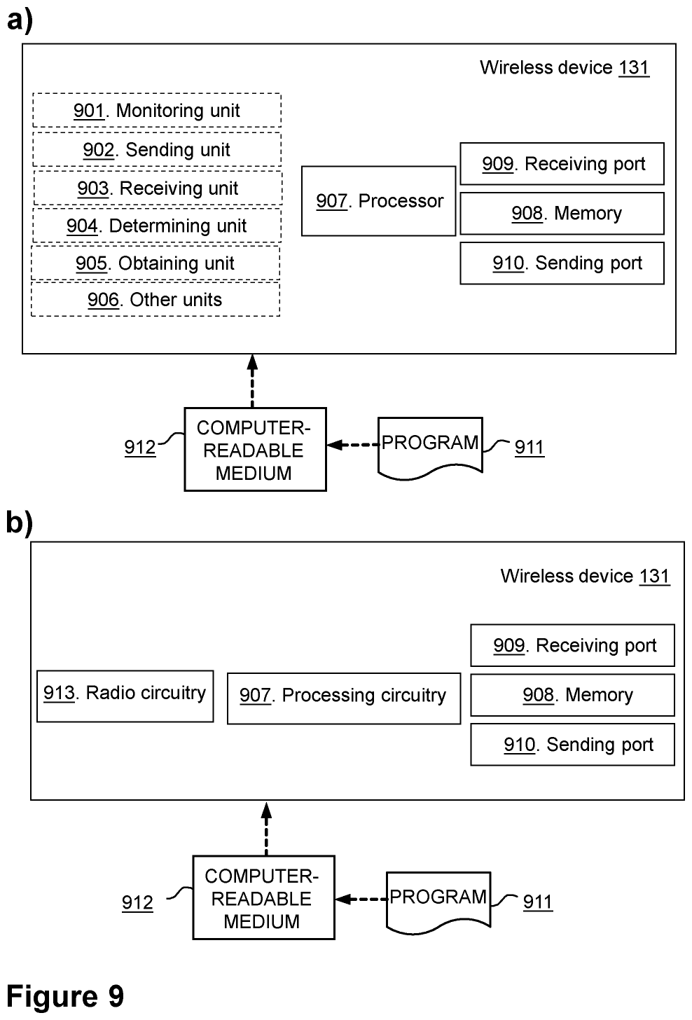

FIG. 9 depicts two different examples in panels a) and b), respectively, of the arrangement that the wireless device 131 may comprise to perform the method actions described above in relation to FIG. 5, FIG. 7 and/or FIG. 8. In some embodiments, the wireless device 131 may comprise the following arrangement depicted in FIG. 9a. The wireless device 131 may be understood to be for handling the transmission. The wireless device 131 is configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 131 and will thus not be repeated here to simplify the description. For example, the first radio signal may be referred to herein as, e.g., a C-WUS.

In FIG. 9, optional units are indicated with dashed boxes.

The wireless device 131 is configured to perform the monitoring in Action 504, e.g., by means of a monitoring unit 901 within the wireless device 131, configured to monitor, in sleep mode, using the first receiver to monitor the first radio signals to wake-up the wireless device 131, whether or not the first radio signal is received from the node 101 configured to operate in the wireless communications network 100. The first radio signal is configured to indicate the wireless device 131 is in coverage of the node 101. The monitoring is configured to be performed with the proviso the wireless device 131 has obtained the information to be sent to the node 101. The first radio signal is configured to be any signal configured to be detectable by a WUR. The first receiver is configured to be the WUR.

The wireless device 131 is configured to perform the sending in Action 508, e.g., by means of a sending unit 902 within the wireless device 131, configured to send the information configured to be obtained to the node 101. The sending is configured to be based on whether or not the wireless device 131 receives the first radio signal during the monitoring. With the proviso the wireless device 131 receives the first radio signal, the first radio signal is configured to wake-up the wireless device 131 from sleep mode by waking-up the second receiver to receive signals other than the first radio signals and the wireless device 131 is further configured to a) send the information to the node 101 while the wireless device 131 is in coverage using the second receiver, b) go back to sleep mode after the sending, and c) refrain from performing the monitoring with the proviso the wireless device 131 lacks further information to be sent. With the proviso the wireless device 131 fails to receive the first radio signal, the wireless device 131 is configured to: a) store the information and b) stay in sleep mode, until the wireless device 131 sends the information, using the second receiver, when the wireless device 131 receives the first radio signal using the first receiver.

In some embodiments, the sending of the information may be configured to be performed in the absence of performing cell selection and/or cell reselection.

The wireless device 131 may be configured to perform the receiving in Action 505, e.g., by means of a receiving unit 903 within the wireless device 131, configured to receive the first radio signal configured to be monitored. The sending may be configured to be based on the first radio signal configured to be received.

The wireless device 131 may be configured to perform the determining in Action 502, e.g., by means of a determining unit 904 within the wireless device 131, configured to determine whether or not there may be any information to be sent. The monitoring may be configured to be performed with the proviso the wireless device 131 determines that the information has been obtained.

The wireless device 131 may be configured to perform the determining in this Action 503, e.g. by means of the determining unit 904 within the wireless device 131, configured to determine the energy level of the wireless device 131, and the monitoring may be configured to be performed with the proviso the determined energy level exceeds the first threshold.

The wireless device 131 may be configured to perform the obtaining in this Action 501, e.g. by means of an obtaining unit 905 within the wireless device 131, configured to obtain the indication. The indication may comprise the first configuration indicating how the wireless device 131 may have to perform the monitoring, and the monitoring may be configured to be performed based on the first configuration configured to be indicated.

In some embodiments, at least one of the following may apply: a) the first radio signal may be configured to wake up the wireless device 131 from sleep mode and it may be configured to be different than the second radio signal; the second radio signal may be configured to wake up the wireless device 131 for downlink reachability, b) the first radio signal may be configured to be periodically transmitted, c) the first radio signal may be configured to be one of: cell specific and network specific, d) the first radio signal may be configured to be a WUR-SSB, e) the first radio signal may be configured to be coordinated with the paging occasions configured to be used with signals to wake-up the wireless device 131, and the first radio signal may be configured to be one of the signals to wake-up the wireless device 131, f) the first radio signal may be configured to be coordinated with the paging occasions configured to be used with signals to wake-up the wireless device 131, and the first radio signal may be configured to be different from and non-overlapping with the signals to wake-up the wireless device 131, g) the signals to wake-up the wireless device 131 and the first radio signal may be configured to be jointly encoded, h) at least one of the periodicity and the second configuration of the first radio signal may be configured to change over time based on the one or more conditions, i) the periodicity of the first radio signal may be configured to be linked to the operation mode of the WUR, and j) coverage enhancement may be configured to be used to monitor the first radio signal.

The wireless device 131 may be configured to perform the determining in Action 506, e.g., by means of the determining unit 904 within the wireless device 131, configured to determine whether or not the wireless device 131 may be in coverage based on whether or not the wireless device 131 receives the first radio signal from the node 101. The sending of the information may be configured to be: i) performed only after the determination and ii) based on the result of the determination.

The wireless device 131 may be configured to perform the determining in Action 507, e.g., by means of the determining unit 904 within the wireless device 131, configured to determine whether or not the coverage of the node 101 matches an uplink coverage. The sending of the information may be configured to be performed with the proviso the match may be determined.

In some embodiments, the second receiver may be configured to remain in the power saving state during the monitoring.

Other units 906 may be comprised in the wireless device 131.

The embodiments herein in the wireless device 131 may be implemented through one or more processors, such as a processor 907 in the wireless device 131 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 131. One such carrier may be in the form of a CD ROM disc. It is however feasible with other data carriers such as a memory stick. The computer program code may furthermore be provided as pure program code on a server and downloaded to the wireless device 131.

The wireless device 131 may further comprise a memory 908 comprising one or more memory units. The memory 908 is arranged to be used to store obtained information, store data, configurations, schedulings, and applications etc. to perform the methods herein when being executed in the wireless device 131.

In some embodiments, the wireless device 131 may receive information from, e.g., the node 101, the network node 110, the core network node 115, the another wireless device 132 or another node, through a receiving port 909. In some embodiments, the receiving port 909 may be, for example, connected to one or more antennas in wireless device 131. In other embodiments, the wireless device 131 may receive information from another structure in the wireless communications network 100 through the receiving port 909. Since the receiving port 909 may be in communication with the processor 907, the receiving port 909 may then send the received information to the processor 907. The receiving port 909 may also be configured to receive other information.

The processor 907 in the wireless device 131 may be further configured to transmit or send information to e.g., the node 101, the network node 110, the core network node 115, the another wireless device 132, another node, or another structure in the wireless communications network 100, through a sending port 910, which may be in communication with the processor 907, and the memory 908.

Those skilled in the art will also appreciate that the different units 901-906 described above may refer to a combination of analog and digital modules, and/or one or more processors configured with software and/or firmware, e.g., stored in memory, that, when executed by the one or more processors such as the processor 907, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 901-906 described above may be implemented as one or more applications running on one or more processors such as the processor 907.

Thus, the methods according to the embodiments described herein for the wireless device 131 may be respectively implemented by means of a computer program 911 product, comprising instructions, i.e., software code portions, which, when executed on at least one processor 907, cause the at least one processor 907 to carry out the actions described herein, as performed by the wireless device 131. The computer program 911 product may be stored on a computer-readable storage medium 912. The computer-readable storage medium 912, having stored thereon the computer program 911, may comprise instructions which, when executed on at least one processor 907, cause the at least one processor 907 to carry out the actions described herein, as performed by the wireless device 131. In some embodiments, the computer-readable storage medium 912 may be a non-transitory computer-readable storage medium, such as a CD ROM disc, or a memory stick. In other embodiments, the computer program 911 product may be stored on a carrier containing the computer program 911 just described, wherein the carrier is one of an electronic signal, optical signal, radio signal, or the computer-readable storage medium 912, as described above.

The wireless device 131 may comprise a communication interface configured to facilitate communications between the wireless device 131 and other nodes or devices, e.g., the node 101, the network node 110, the core network node 115, the another wireless device 132, another node, or another structure in the wireless communications network 100. The interface may, for example, include a transceiver configured to transmit and receive radio signals over an air interface in accordance with a suitable standard.

In other embodiments, the wireless device 131 may comprise the following arrangement depicted in FIG. 9b. The wireless device 131 may comprise a processing circuitry 907, e.g., one or more processors such as the processor 907, in the wireless device 131 and the memory 908. The wireless device 131 may also comprise a radio circuitry 913, which may comprise e.g., the receiving port 909 and the sending port 910. The processing circuitry 913 may be configured to, or operable to, perform the method actions according to FIG. 5, FIG. 7 and/or FIG. 8, in a similar manner as that described in relation to FIG. 9a. The radio circuitry 913 may be configured to set up and maintain at least a wireless connection with the node 101, the network node 110, the core network node 115, the another wireless device 132, another node, or another structure in the wireless communications network 100. Circuitry may be understood herein as a hardware component.

Hence, embodiments herein also relate to the wireless device 131 comprising the processing circuitry 907 and the memory 908, said memory 908 containing instructions executable by said processing circuitry 907, whereby the wireless device 131 is operative to perform the actions described herein in relation to the wireless device 131, e.g., in FIG. 5, FIG. 7 and/or FIG. 8.

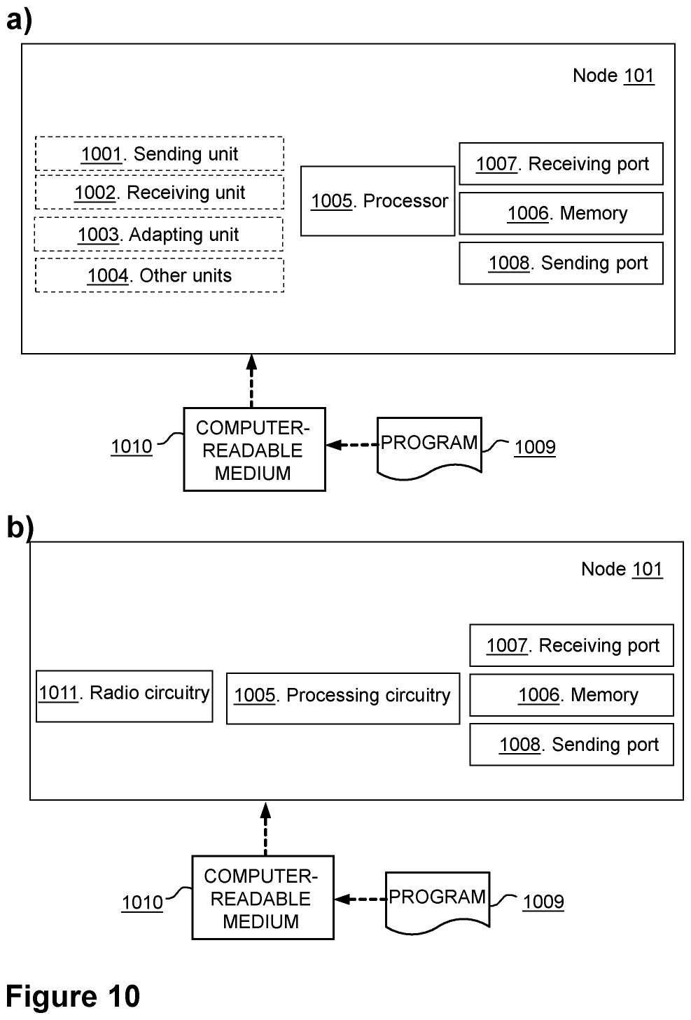

FIG. 10 depicts two different examples in panels a) and b), respectively, of the arrangement that the node 101 may comprise to perform the method actions described above in relation to FIG. 6, FIG. 7 and/or FIG. 8. In some embodiments, the node 101 may comprise the following arrangement depicted in FIG. 10a. The node 111 may be understood to be for handling the transmission. The node 111 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 131 and will thus not be repeated here. For example, the first radio signal may be referred to herein as, e.g., a C-WUS.

In FIG. 10, optional units are indicated with dashed boxes.

The node 101 is configured to perform the sending in Action 603, e.g., by means of a sending unit 1001 within the node 101, configured to send the first radio signal. The first radio signal is configured to indicate the wireless device 131 configured to operate in the wireless communications network 100 is in coverage of the node 101. The first radio signal is configured to wake up the wireless device 131 from sleep mode when received by the first receiver configured to be used by the wireless device 131 to monitor first radio signals to wake-up the wireless device 131. The first receiver is configured to be a WUR. The first radio signal is configured to be any signal configured to be detectable by the WUR.

The node 101 is configured to perform the receiving in Action 604, e.g. by means of a receiving unit 1002 within the node 101, configured to receive the information, from the wireless device 131. The receiving is configured to be based on the first radio signal configured to be sent. The receiving is from the second receiver configured to receive the signals other than the first radio signals, and configured to be woken-up at the wireless device 131 by the first radio signal configured to be sent.

The node 101 may be configured to perform the sending in Action 601, e.g. by means of the sending unit 1001 within the node 101, configured to send the indication to the wireless device 131. The indication is configured to comprise the first configuration configured to indicate how the wireless device 131 is to monitor the first radio signal. The receiving is configured to be based on the first configuration configured to be indicated.

The node 101 may be configured to perform the receiving in this Action 602, e.g. by means of an adapting unit 1003 within the node 101, configured to adapt the power of transmission of the first radio signal. The first radio signal is configured to be transmitted with the adapted power. The receiving is configured to be based on the transmitted first radio signal configured to be adapted.

In some embodiments, at least one of the following may apply: a) the first radio signal may be configured to wake up the wireless device 131 from sleep mode and it may be configured to be different than the second radio signal; the second radio signal may be configured to wake up the wireless device 131 for downlink reachability, b) the first radio signal may be configured to be periodically sent, c) the first radio signal may be configured to be one of: cell specific and network specific, d) the first radio signal may be configured to be a WUR-SSB, e) the first radio signal may be configured to be coordinated with the paging occasions configured to be used with signals to wake-up the wireless device 131, and the first radio signal may be configured to be one of the signals to wake-up the wireless device 131, f) the first radio signal may be configured to be coordinated with the paging occasions configured to be used with signals to wake-up the wireless device 131, and the first radio signal may be configured to be different from and non-overlapping with the signals to wake-up the wireless device 131, g) the signals to wake-up the wireless device 131 and the first radio signal may be configured to be jointly encoded, h) at least one of the periodicity and the second configuration of the first radio signal may be configured to change over time based on the one or more conditions, i) the receiving of the information may be configured to be performed in the absence of performing cell selection and/or cell reselection, and j) the periodicity of the first radio signal may be configured to be linked to the operation mode of the WUR.

Other units 1004 may be comprised in the node 101.

The embodiments herein in the node 101 may be implemented through one or more processors, such as a processor 1005 in the node 101 depicted in FIG. 10a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the node 101. One such carrier may be in the form of a CD ROM disc. It is however feasible with other data carriers such as a memory stick. The computer program code may furthermore be provided as pure program code on a server and downloaded to the node 101.

The node 101 may further comprise a memory 1006 comprising one or more memory units. The memory 1006 is arranged to be used to store obtained information, store data, configurations, schedulings, and applications etc. to perform the methods herein when being executed in the node 101.

In some embodiments, the node 101 may receive information from, e.g., the wireless device 131, the another wireless device 132, the network node 110, the core network node 115, or another node, through a receiving port 1007. In some embodiments, the receiving port 1007 may be, for example, connected to one or more antennas in node 101. In other embodiments, the node 101 may receive information from another structure in the wireless communications network 100 through the receiving port 1007. Since the receiving port 1007 may be in communication with the processor 1005, the receiving port 1007 may then send the received information to the processor 1005. The receiving port 1007 may also be configured to receive other information.

The processor 1005 in the node 101 may be further configured to transmit or send information to e.g. the wireless device 131, the another wireless device 132, the network node 110, the core network node 115, another node, or another structure in the wireless communications network 100, through a sending port 1008, which may be in communication with the processor 1005, and the memory 1006.

Those skilled in the art will also appreciate that the different units 1001-1004 described above may refer to a combination of analog and digital modules, and/or one or more processors configured with software and/or firmware, e.g., stored in memory, that, when executed by the one or more processors such as the processor 1005, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1001-1004 described above may be implemented as one or more applications running on one or more processors such as the processor 1005.

Thus, the methods according to the embodiments described herein for the node 101 may be respectively implemented by means of a computer program 1009 product, comprising instructions, i.e., software code portions, which, when executed on at least one processor 1005, cause the at least one processor 1005 to carry out the actions described herein, as performed by the node 101. The computer program 1009 product may be stored on a computer-readable storage medium 1010. The computer-readable storage medium 1010, having stored thereon the computer program 1009, may comprise instructions which, when executed on at least one processor 1005, cause the at least one processor 1005 to carry out the actions described herein, as performed by the node 101. In some embodiments, the computer-readable storage medium 1010 may be a non-transitory computer-readable storage medium, such as a CD ROM disc, or a memory stick. In other embodiments, the computer program 1009 product may be stored on a carrier containing the computer program 1009 just described, wherein the carrier is one of an electronic signal, optical signal, radio signal, or the computer-readable storage medium 1010, as described above.

The node 101 may comprise a communication interface configured to facilitate communications between the node 101 and other nodes or devices, e.g., the wireless device 131, the another wireless device 132, the network node 110, the core network node 115, another node, or another structure in the wireless communications network 100. The interface may, for example, include a transceiver configured to transmit and receive radio signals over an air interface in accordance with a suitable standard.

In other embodiments, the node 101 may comprise the following arrangement depicted in FIG. 10b. The node 101 may comprise a processing circuitry 1005, e.g., one or more processors such as the processor 1005, in the node 101 and the memory 1006. The node 101 may also comprise a radio circuitry 1011, which may comprise e.g., the receiving port 1007 and the sending port 1008. The processing circuitry 1005 may be configured to, or operable to, perform the method actions according to FIG. 6, FIG. 7 and/or FIG. 8, in a similar manner as that described in relation to FIG. 10a. The radio circuitry 1011 may be configured to set up and maintain at least a wireless connection with the wireless device 131, the another wireless device 132, the network node 110, the core network node 115, another node, or another structure in the wireless communications network 100. Circuitry may be understood herein as a hardware component.

Hence, embodiments herein also relate to the node 101 comprising the processing circuitry 1005 and the memory 1006, said memory 1006 containing instructions executable by said processing circuitry 1005, whereby the node 101 is operative to perform the actions described herein in relation to the node 101, e.g., in FIG. 6, FIG. 7 and/or FIG. 8.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Examples related to embodiments herein:

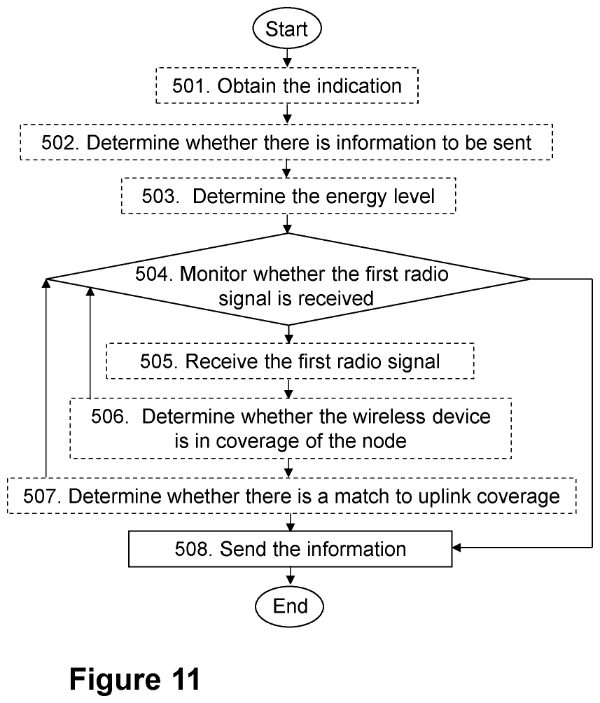

The wireless device 131 embodiments relate to FIG. 11, FIGS. 7-8, FIG. 9 and FIGS. 13-18.

A method, performed by a wireless device, such as the wireless device 131 is described herein. The method may be understood to be for transmission. The wireless device 131 may be operating in a wireless communications network, such as the wireless communications network 100.

The method may comprise one or more of the following actions. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 131 is depicted in FIG. 11. In FIG. 11, optional actions in some embodiments may be represented with dashed lines.

Monitoring 504 whether or not a first radio signal is received. The wireless device 131 may be configured to perform the monitoring in this Action 504, e.g., by means of a monitoring unit 901 within the wireless device 131, configured to perform this action.

Monitoring in this Action 504 may comprise measuring or checking.

The monitoring may be of whether or not the first radio signal is received from the node 101 operating in the wireless communications network 100.

The first radio signal may indicate the wireless device 131 is in coverage of the node 101.

The monitoring in this Action 504 may be performed with the proviso the wireless device 131 may have obtained information to be sent, e.g., uplink, to the node 101.

The wireless device 131 may refrain from performing the monitoring 504 otherwise. That is, in the absence of having obtained information to be sent, e.g., uplink, to the node 101.

In some embodiments, the first radio signal may wake up the wireless device 131 from sleep mode. The wireless device 131 may reside in sleep mode until the first radio signal wakes up the wireless device 131 from sleep mode.

In some embodiments, at least one of the following may apply:
the first radio signal may wake up the wireless device 131 from sleep mode and it may be different than a second radio signal, wherein the second radio signal may wake up the wireless device 131 for downlink reachability; the first radio signal may be, in some examples, be referred to herein as a C-WUS,
the first radio signal may be periodically received,
the first radio signal may be one of: cell specific and network specific,
the first radio signal may be any signal detectable by a Wake-Up Receiver (WUR),
the first radio signal may be coordinated with paging occasions used with signals to wake-up the wireless device 131, and the first radio signal may be one of the signals to wake-up the wireless device 131,
the first radio signal may be coordinated with paging occasions used with signals to wake-up the wireless device 131, and the first radio signal may be different from and non-overlapping with the signals to wake-up the wireless device 131,
the signals to wake-up the wireless device 131 and the first radio signal may be jointly encoded,
at least one of a periodicity and a second configuration of the first radio signal may change over time based on one or more conditions,
the periodicity of the first radio signal may be linked to an operation mode of the WUR, and
coverage enhancement may be used to monitor the first radio signal.

Sending/Transmitting 508 the obtained information. The wireless device 131 may be configured to perform the sending in this Action 508, e.g. by means of a sending unit 902 within the wireless device 131, configured to perform this action.

The sending in this Action 508 of the obtained information may be to the node 101, e.g., in the uplink.

The sending in this Action 508 may be based on whether or not the wireless device 131 receives the first radio signal during the monitoring in Action 504.

With the proviso the wireless device 131 receives the first radio signal, the wireless device 131 may: a) send the information to the node 101 while the wireless device 131 is in coverage, b) go back to sleep mode after the sending 508, and c) refrain from performing the monitoring 504 with the proviso the wireless device 130 may lack further information to be sent, e.g., in the uplink.

With the proviso the wireless device 131 fails to receive the first radio signal, that is, during the monitoring 504, the wireless device 131 may: a) store the information and b) stay in sleep mode, e.g., until the wireless device 131 sends the information when the wireless device 131 receives the first radio signal.

In some embodiments, the sending in this Action 508 of the information may be performed in the absence of performing cell selection and/or cell reselection.

In some embodiments, the method may further comprise one or more of the following actions:

Receiving 505 the monitored first radio signal. The wireless device 131 may be configured to perform the receiving in this Action 505, e.g., by means of a receiving unit 903 within the wireless device 131, configured to perform this action.

The sending in Action 508 may be based on the received first radio signal.

Determining 502 whether or not there may be any information to be sent. The wireless device 131 may be configured to perform the determining in this Action 502, e.g., by means of a determining unit 904 within the wireless device 131, configured to perform this action.

Determining in this Action 502 may comprise deciding, calculating or checking.

The determining in this Action 502 may be of whether or not there may be any information to be sent in the uplink.

The monitoring in Action 504 may be performed with the proviso the wireless device 130 may determine that the information has been obtained, e.g., and may refrain from performing the monitoring in Action 504 otherwise.

Determining 503 an energy level of the wireless device 131. The wireless device 131 may be configured to perform the determining in this Action 503, e.g., by means of the determining unit 904 within the wireless device 131, configured to perform this action.

The monitoring in this Action 504 may be performed with the proviso the determined energy level may exceed a first threshold.

Obtaining 501 an indication. The wireless device 131 may be configured to perform the obtaining in this Action 501, e.g., by means of an obtaining unit 905 within the wireless device 131, configured to perform this action.

Obtaining may be, e.g., receiving from the network node 110, e.g., from the node 101, e.g., the node 101 being the network node 110 or another node, or retrieving from a memory.

The indication may comprise a first configuration. The first indication may indicate how the wireless device 131 is to perform the monitoring in Action 505. The monitoring in Action 505 may be performed based on the indicated first configuration.

Determining 506 whether or not the wireless device 131 is in coverage. The wireless device 131 may be configured to perform the determining in this Action 506, e.g., by means of the determining unit 904 within the wireless device 131, configured to perform this action.

The determining in this Action 506 may be based on whether or not the wireless device 131 may receive the first radio signal from the node 101, e.g., based on the first radio signal having a strength above a second threshold.

The sending in this Action 508 of the information may be: i) performed only after the determination and ii) based on a result of the determination.

Determining 507 whether or not the coverage of the node 101 matches an, e.g., uplink, coverage of, e.g., uplink, transmission of the wireless device 131. The wireless device 131 may be configured to perform the determining in this Action 503, e.g., by means of the determining unit 904 within the wireless device 131, configured to perform this action.

The sending in this Action 508 of the information 504 may be performed with the proviso the match may be determined.

In some embodiments, the wireless device 131 may uses a first receiver to monitor first radio signals to wake-up the wireless device 131 and a second receiver to receive signals other than the first radio signals. The second receiver may remain in a power saving state during the sending in Action 508 of the information.

In some embodiments, the wireless device 131 may be a battery-less device. The node may be one of: the network node 110, the core network node 115, and the another wireless device 132.

Other units 906 may be comprised in the wireless device 131.

The wireless device 131 may also be configured to communicate user data with a host application unit in a host computer 1410, e.g., via another link such as 1460.

In FIG. 9, optional units are indicated with dashed boxes.

The wireless device 131 may comprise an interface unit to facilitate communications between the wireless device 131 and other nodes or devices, e.g., the node 101, the network node 110, the core network node 115, the another wireless device 132, the host computer 1410, or any of the other nodes. In some particular examples, the interface may, for example, include a transceiver configured to transmit and receive radio signals over an air interface in accordance with a suitable standard.

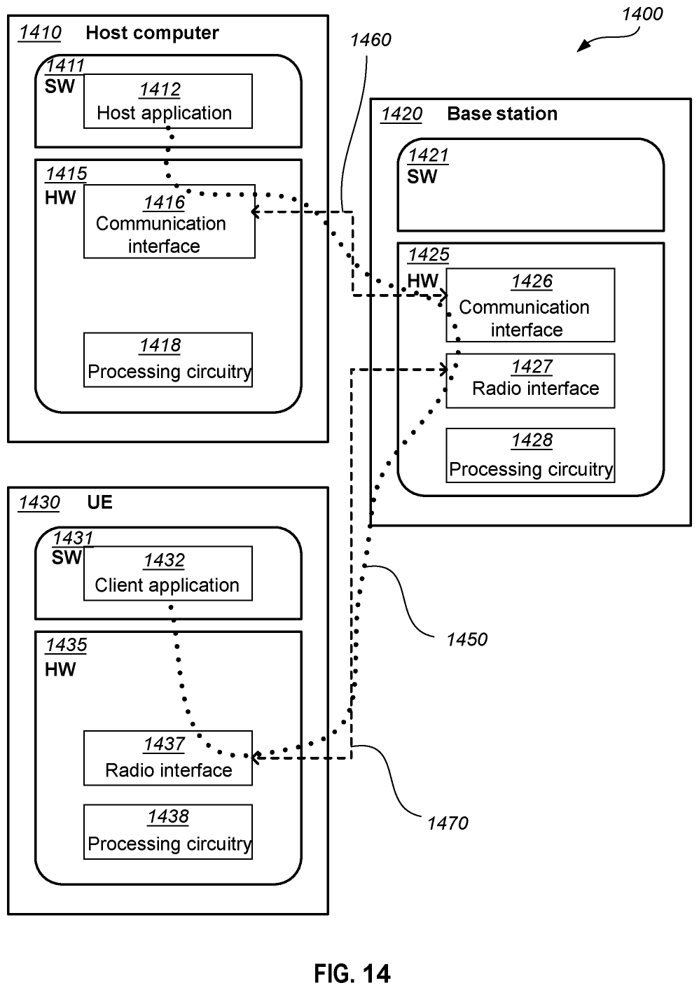

The wireless device 131 may comprise an arrangement as shown in FIG. 9 or in FIG. 14.

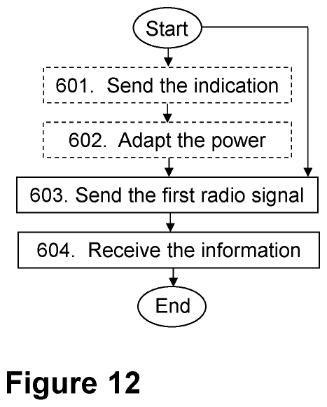

The node 101 embodiments relate to FIG. 12, FIG. 7, FIG. 8, FIG. 10 and FIGS. 13-18.

A method, performed by a node, such as the node 101, is described herein. The method may be understood to be for handling a transmission. The node 101 may be operating in a wireless communications network, such as the wireless communications network 100.

The method may comprise one or more of the following actions. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the node 101 is depicted in FIG. 12. In FIG. 12, optional actions in some embodiments may be represented with dashed lines.

The detailed description of some of the following corresponds to the same references provided above, in relation to the actions described for the wireless device 131 and will thus not be repeated here to simplify the description. For example, the first radio signal may be referred to herein as, e.g., a C-WUS.

Sending/Transmitting 603 the first radio signal. The node 101 may be configured to perform this sending in this Action 603, e.g., by means of a sending unit 1001 within the node 101, configured to perform this action.

The first radio signal may indicate the wireless device 131 operating in the wireless communications network 100 is in coverage of the node 101.

The first radio signal may wake up the wireless device 131 from sleep mode.

Receiving 604 the information. The node 101 may be configured to perform the receiving in this Action 604, e.g., by means of a receiving unit 1002 within the node 101, configured to perform this action.

The receiving of the information may be, e.g., in the uplink, from the wireless device 131. The receiving in Action 604 may be based on the received first radio signal.

In some embodiments, at least one of the following may apply:
the first radio signal may wake up the wireless device 131 from sleep mode and it may be different than the second radio signal, wherein the second radio signal may wake up the wireless device 131 for downlink reachability;
the first radio signal may be periodically sent,
the first radio signal may be one of: cell specific and network specific,
the first radio signal may be any signal detectable by a WUR,
the first radio signal may be coordinated with paging occasions used with signals to wake-up the wireless device 131, and the first radio signal may be one of the signals to wake-up the wireless device 131,
the first radio signal may be coordinated with paging occasions used with signals to wake-up the wireless device 131, and the first radio signal may be different from and non-overlapping with the signals to wake-up the wireless device 131,
the signals to wake-up the wireless device 131 and the first radio signal may be jointly encoded,
at least one of the periodicity and the second configuration of the first radio signal may change over time based on the one or more conditions,
the receiving in Action 604 of the information may be performed in the absence of performing cell selection and/or cell reselection, and
the periodicity of the first radio signal may be linked to an operation mode of the WUR.

In some embodiments, the method may further comprise one or more of the following actions:

Sending 601 the indication. The node 101 may be configured to perform the sending in this Action 601, e.g. by means of the sending unit 1001 within the node 101, configured to perform this action.

The sending in this Action 601 may be to the wireless device 131.

The indication may comprise the first configuration indicating how the wireless device 131 may have to monitor the first radio signal. The receiving in Action 604 may be based on the indicated first configuration.

In some embodiments, the wireless device 131 may be a battery-less device. The node may be one of: the network node 110, the core network node 115, and the another wireless device 132.

This Action 601 may be performed in embodiments wherein e.g., the node 101 may be the network node 110.

Adapting 602 a power of transmission. The node 101 may be configured to perform the receiving in this Action 604, e.g., by means of a receiving unit 1002 within the node 101, configured to perform this action.

The power of transmission may be of the first radio signal.

The first radio signal may be transmitted with the adapted power. The receiving in Action 604 may be based on the adapted transmitted first radio signal.

This Action 602 may be performed in embodiments wherein e.g., the node 101 may be the network node 110.

Other units 1004 may be comprised in the node 101.

The node 101 may also be configured to communicate user data with a host application unit in a host computer 1410, e.g., via another link such as 1460.

In FIG. 10, optional units are indicated with dashed boxes.

The node 101 may comprise an interface unit to facilitate communications between the node 101 and other nodes or devices, e.g., the wireless device 131, the another wireless device 132, the network node 110, the core network node 115, the host computer 1410, or any of the other nodes. In some particular examples, the interface may, for example, include a transceiver configured to transmit and receive radio signals over an air interface in accordance with a suitable standard.

The node 101 may comprise an arrangement as shown in FIG. 10 or in FIG. 14.

EXAMPLES related to embodiments herein:

Example 1. A method performed by a wireless device (131), the method being for handling a transmission, the wireless device (131) operating in a wireless communications network (100), and the method comprising: monitoring (504) whether or not a first radio signal is received from a node (101) operating in the wireless communications network (100), wherein the first radio signal indicates the wireless device (131) is in coverage of the node (101), wherein the monitoring (504) is performed with the proviso the wireless device (131) has obtained information to be sent, e.g., uplink, to the node (101), e.g., and refrains from performing the monitoring (504) otherwise, that is, in the absence of having obtained information to be sent, e.g., uplink, to the node (101), and sending/transmitting (508) the obtained information, e.g., in the uplink, to the node (101), the sending (508) being based on whether or not the wireless device (131) receives the first radio signal during the monitoring (504), wherein: i) with the proviso the wireless device (131) receives the first radio signal, the wireless device (131) a) sends the information to the node (101) while the wireless device (131) is in coverage, b) goes back to sleep mode after the sending (508), and c) refrains from performing the monitoring (504) with the proviso the wireless device (130) lacks further information to be sent, e.g., in the uplink, and ii) with the proviso the wireless device (131) fails to receive the first radio signal, the wireless device (131): a) stores the information and b) stays in sleep mode, until the wireless device (131) sends the information when the wireless device (131) receives the first radio signal.

Example 2. The method according to example 1, wherein the first radio signal wakes up the wireless device (131) from sleep mode, e.g., the wireless device (131) resides in sleep mode until the first radio signal wakes up the wireless device (131) from sleep mode.

Example 3. The method according to any of examples 1-2, wherein the sending (508) of the information is performed in the absence of performing cell selection and/or cell reselection.

Example 4. The method according to any of examples 1-3, further comprising: receiving (505) the monitored first radio signal, and wherein the sending (508) is based on the received first radio signal.

Example 5. The method according to any of examples 1-4, further comprising at least one of: determining (502) whether or not there is any information to be sent, e.g., in the uplink, and wherein the monitoring (504) is performed with the proviso the wireless device (130) determines that the information has been obtained, e.g., and refrains from performing the monitoring (504) otherwise, and determining (503) an energy level of the wireless device (131), and wherein the monitoring (504) is performed with the proviso the determined energy level exceeds a first threshold.

Example 6. The method according to any of examples 1-5, further comprising: obtaining (501) an indication, e.g., from the node (101), e.g., the node (101) being a network node (110), the indication comprising a first configuration indicating how the wireless device (131) is to perform the monitoring (505), and wherein the monitoring (505) is performed based on the indicated first configuration.

Example 7. The method according to any of examples 1-6, wherein at least one of: the first radio signal wakes up the wireless device (131) from sleep mode and it is different than a second radio signal wherein the second radio signal wakes up the wireless device (131) for downlink reachability, the first radio signal is periodically received, the first radio signal is one of: cell specific and network specific, the first radio signal is any signal detectable by a Wake-Up Receiver, WUR, the first radio signal is coordinated with paging occasions used with signals to wake-up the wireless device (131), and the first radio signal is one of the signals to wake-up the wireless device (131), the first radio signal is coordinated with paging occasions used with signals to wake-up the wireless device (131), and the first radio signal is different from and non-overlapping with the signals to wake-up the wireless device (131), the signals to wake-up the wireless device (131) and the first radio signal are jointly encoded, at least one of a periodicity and a second configuration of the first radio signal changes over time based on one or more conditions, the periodicity of the first radio signal is linked to an operation mode of the WUR, and coverage enhancement is used to monitor the first radio signal.

Example 8. The method according to any of examples 1-7, the method further comprising:—determining (506) whether or not the wireless device (131) is in coverage based on whether or not the wireless device (131) receives the first radio signal from the node (101), e.g., based on the first radio signal having a strength above a second threshold, and wherein the sending (508) of the information is: i) performed only after the determination and ii) based on a result of the determination.

Example 9. The method according to any of examples 1-8, further comprising:—determining (507) whether or not the coverage of the node (101) matches an, e.g., uplink coverage of, e.g., uplink transmission of the wireless device (131), and wherein the sending (508) of the information is performed with the proviso the match is determined.

Example 10. The method according to any of examples 1-9, wherein the wireless device (131) uses a first receiver to monitor first radio signals to wake-up the wireless device (131) and a second receiver to receive signals other than the first radio signals, and wherein the second receiver remains in a power saving state during the sending (508) of the information.

Example 11. The method according to any of examples 1-10, wherein the wireless device (131) is a battery-less device, and wherein the node (101) is one of: a network node (110), a core network node (115), and another wireless device (132).

Example 12. A method performed by a node (101), the method being for handling a transmission, the node (101) operating in a wireless communications network (100), and the method comprising: sending/transmitting (603) a first radio signal, wherein the first radio signal indicates a wireless device (131) operating in the wireless communications network (100) is in coverage of the node (101), wherein the first radio signal wakes up the wireless device (131) from sleep mode, and receiving (604) information, e.g., in the uplink, from the wireless device (131), wherein the receiving (604) is based on the received first radio signal.

Example 13. The method according to example 12, wherein e.g., the node (101) is a network node (101, 110), the method further comprising at least one of: sending (601) an indication to the wireless device (131), the indication comprising a first configuration indicating how the wireless device (131) is to monitor the first radio signal, and wherein the receiving (604) is based on the indicated first configuration, and adapting (602) a power of transmission of the first radio signal, and wherein the first radio signal is transmitted with the adapted power, and wherein the receiving (604) is based on the adapted transmitted first radio signal.

Example 14. The method according to any of examples 12-13, wherein at least one of: the first radio signal wakes up the wireless device (131) from sleep mode and it is different than a second radio signal wherein the second radio signal wakes up the wireless device (131) for downlink reachability, the first radio signal is periodically sent, the first radio signal is one of: cell specific and network specific, the first radio signal is any signal detectable by a Wake-Up Receiver, WUR, the first radio signal is coordinated with paging occasions used with signals to wake-up the wireless device (131), and the first radio signal is one of the signals to wake-up the wireless device (131), the first radio signal is coordinated with paging occasions used with signals to wake-up the wireless device (131), and the first radio signal is different from and non-overlapping with the signals to wake-up the wireless device (131), the signals to wake-up the wireless device (131) and the first radio signal are jointly encoded, at least one of a periodicity and a second configuration of the first radio signal changes over time based on one or more conditions, e.g., the second configuration may be comprised in the first configuration, the receiving (604) of the information is performed in the absence of performing cell selection and/or cell reselection, and the periodicity of the first radio signal is linked to an operation mode of the WUR.

Example 15. The method according to any of examples 12-14, wherein the wireless device (131) is a battery-less device, and wherein the node (101) is one of: a network node (110), a core network node (115), and another wireless device (132).

### Further Extensions And Variations

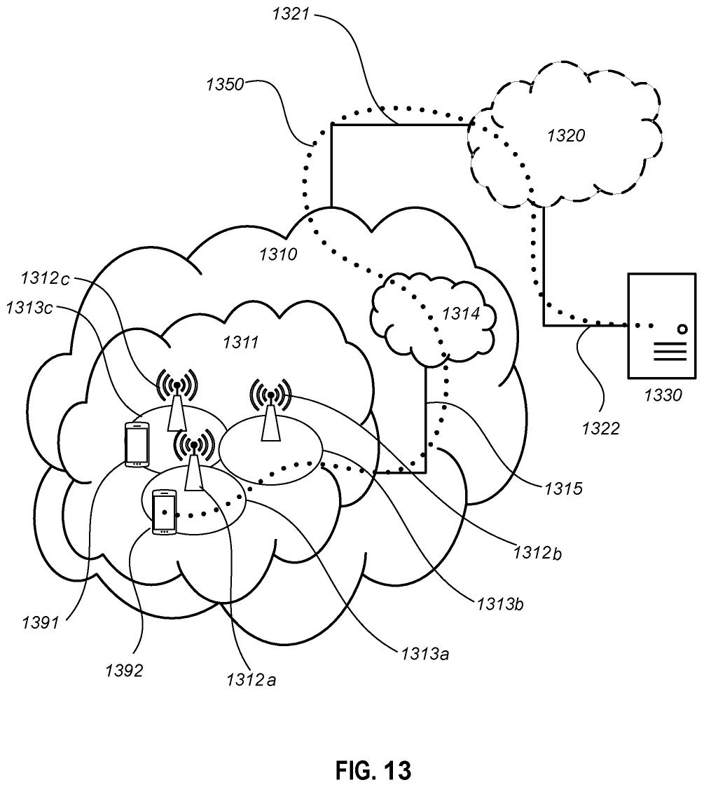

FIG. 13: Telecommunication network connected via an intermediate network to a host computer in accordance with some embodiments

With reference to FIG. 13, in accordance with an embodiment, a communication system includes telecommunication network 1310 such as the wireless communications network 100, for example, a 3GPP-type cellular network, which comprises access network 1311, such as a radio access network, and core network 1314. Access network 1311 comprises a plurality of network nodes such as the network node 110. For example, base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A plurality of user equipments, such as the wireless device 131 are comprised in the wireless communications network 100. In FIG. 13, a first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312. Any of the UEs 1391, 1392 are examples of the wireless device 131.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 13 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

In relation to FIGS. 14, 15, 16, 17, and 18, which are described next, it may be understood that a UE is an example of the wireless device 131, and that any description provided for the UE equally applies to the wireless device 131. It may be also understood that the base station is an example of the network node 110, and that any description provided for the base station equally applies to the network node 110.

FIG. 14: Host computer communicating via a base station with a user equipment over a partially wireless connection in accordance with some embodiments

Example implementations, in accordance with an embodiment, of the wireless device 131, e.g., a UE, the network node 110, e.g., a base station and host computer discussed in the preceding paragraphs will now be described with reference to FIG. 14. In communication system 1400, such as the wireless communications network 100, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes the network node 110, exemplified in FIG. 14 as a base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with the wireless device 131, exemplified in FIG. 14 as a UE 1430 located in a coverage area (not shown in FIG. 14) served by base station 1420. Communication interface 1426 may be configured to facilitate connection 1460 to host computer 1410. Connection 1460 may be direct or it may pass through a core network (not shown in FIG. 14) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 14 may be similar or identical to host computer 1330, one of base stations 1312a, 1312b, 1312c and one of UEs 1391, 1392 of FIG. 13, respectively. This is to say, the inner workings of these entities may be as shown in FIG. 14 and independently, the surrounding network topology may be that of FIG. 13.

In FIG. 14, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

The wireless device 131 embodiments relate to FIG. 5, FIGS. 7-8, FIG. 9 and FIGS. 13-18.

The wireless device 131 may also be configured to communicate user data with a host application unit in a host computer 1410, e.g., via another link such as 1460.

The wireless device 131 may comprise an interface unit to facilitate communications between the wireless device 131 and other nodes or devices, e.g., the node 101, the network node 110, the core network node 115, the another wireless device 132, the host computer 1410, or any of the other nodes. In some particular examples, the interface may, for example, include a transceiver configured to transmit and receive radio signals over an air interface in accordance with a suitable standard.

The wireless device 131 may comprise an arrangement as shown in FIG. 9 or in FIG. 14.

The node 101 embodiments relate to FIG. 6, FIG. 7, FIG. 8, FIG. 10 and FIGS. 13-18.

This Action 602 may be performed in embodiments wherein e.g., the node 101 may be the network node 110.

The node 101 may also be configured to communicate user data with a host application unit in a host computer 1410, e.g., via another link such as 1460.

The node 101 may comprise an interface unit to facilitate communications between the node 101 and other nodes or devices, e.g., the wireless device 131, the another wireless device 132, the network node 110, the core network node 115, the host computer 1410, or any of the other nodes. In some particular examples, the interface may, for example, include a transceiver configured to transmit and receive radio signals over an air interface in accordance with a suitable standard.

The node 101 may comprise an arrangement as shown in FIG. 10 or in FIG. 14.

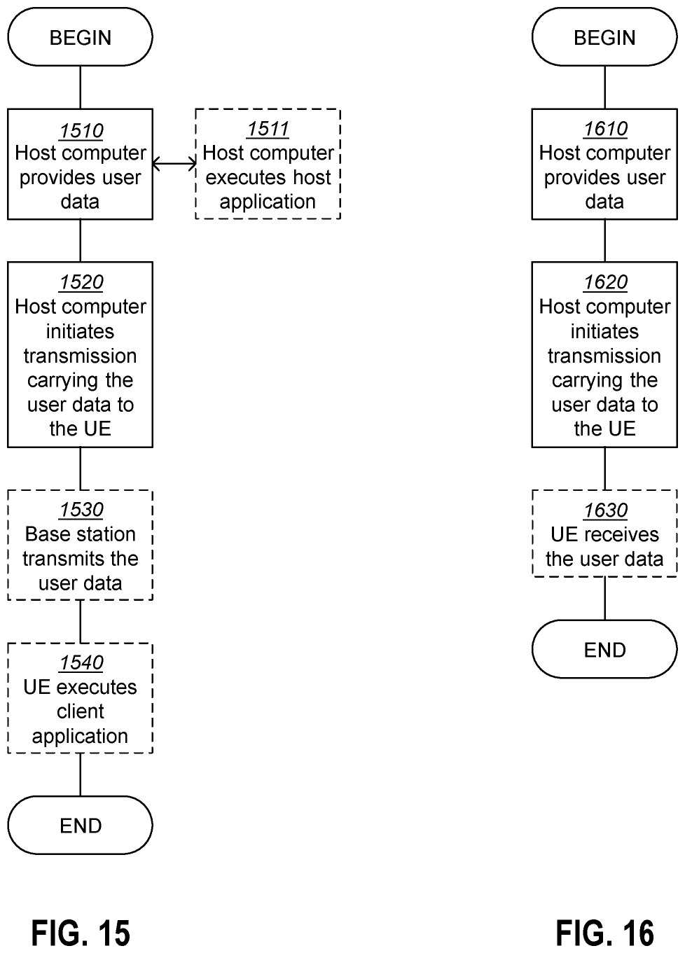

FIG. 15: Methods implemented in a communication system including a host computer, a base station and a user equipment in accordance with some embodiments

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

FIG. 16: Methods implemented in a communication system including a host computer, a base station and a user equipment in accordance with some embodiments

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

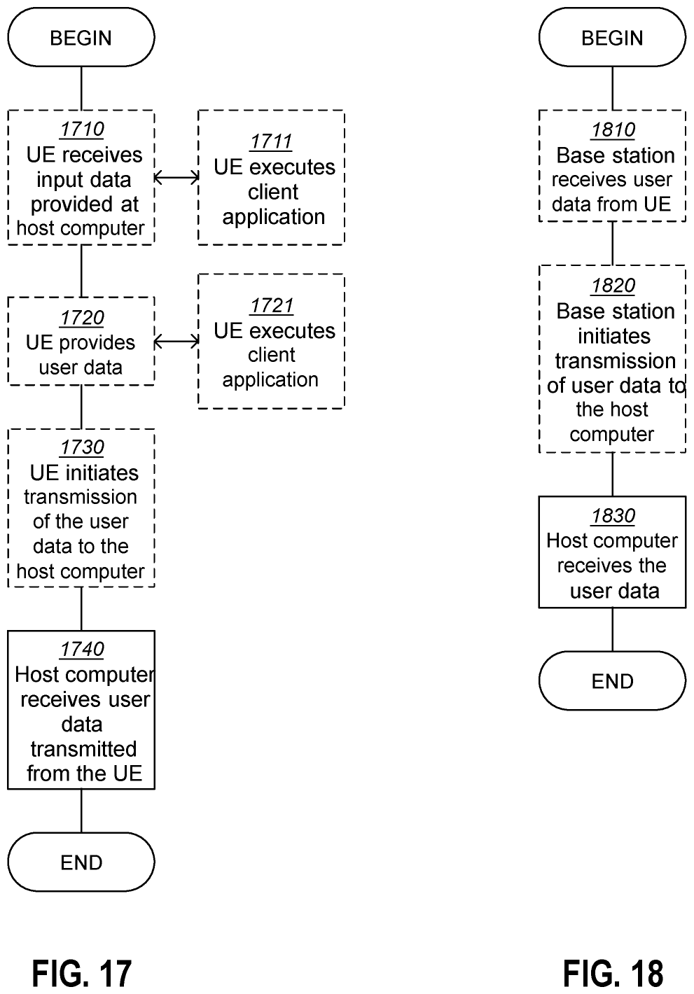

FIG. 17: Methods implemented in a communication system including a host computer, a base station and a user equipment in accordance with some embodiments

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

FIG. 18: Methods implemented in a communication system including a host computer, a base station and a user equipment in accordance with some embodiments

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the network node 110.

5. A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform one or more of the actions described herein as performed by the network node 110.

6. The communication system of embodiment 5, further including the base station.

7. The communication system of embodiment 6, further including the UE, wherein the UE is configured to communicate with the base station.

8. The communication system of embodiment 7, wherein: the processing circuitry of the host computer is configured to execute a host application, thereby providing the user data; and the UE comprises processing circuitry configured to execute a client application associated with the host application.

11. A method implemented in a base station, comprising one or more of the actions described herein as performed by the network node 110.

15. A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs one or more of the actions described herein as performed by the network node 110.

16. The method of embodiment 15, further comprising: at the base station, transmitting the user data.

17. The method of embodiment 16, wherein the user data is provided at the host computer by executing a host application, the method further comprising: at the UE, executing a client application associated with the host application.

21. A user equipment (UE) configured to communicate with a base station, the UE comprising a radio interface and processing circuitry configured to perform one or more of the actions described herein as performed by the wireless device 131.

25. A communication system including a host computer comprising: processing circuitry configured to provide user data; and a communication interface configured to forward user data to a cellular network for transmission to a user equipment (UE), wherein the UE comprises a radio interface and processing circuitry, the UE's processing circuitry configured to perform one or more of the actions described herein as performed by the wireless device 131.

26. The communication system of embodiment 25, further including the UE.

27. The communication system of embodiment 26, wherein the cellular network further includes a base station configured to communicate with the UE.

28. The communication system of embodiment 26 or 27, wherein: the processing circuitry of the host computer is configured to execute a host application, thereby providing the user data; and the UE's processing circuitry is configured to execute a client application associated with the host application.

31. A method implemented in a user equipment (UE), comprising one or more of the actions described herein as performed by the wireless device 131.

35. A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs one or more of the actions described herein as performed by the wireless device 131.

36. The method of embodiment 35, further comprising: at the UE, receiving the user data from the base station.

41. A user equipment (UE) configured to communicate with a base station, the UE comprising a radio interface and processing circuitry configured to perform one or more of the actions described herein as performed by the wireless device 131.

45. A communication system including a host computer comprising: a communication interface configured to receive user data originating from a transmission from a user equipment (UE) to a base station, wherein the UE comprises a radio interface and processing circuitry, the UE's processing circuitry configured to: perform one or more of the actions described herein as performed by the wireless device 131.

46. The communication system of embodiment 45, further including the UE.

47. The communication system of embodiment 46, further including the base station, wherein the base station comprises a radio interface configured to communicate with the UE and a communication interface configured to forward to the host computer the user data carried by a transmission from the UE to the base station.

48. The communication system of embodiment 46 or 47, wherein: the processing circuitry of the host computer is configured to execute a host application; and the UE's processing circuitry is configured to execute a client application associated with the host application, thereby providing the user data.

49. The communication system of embodiment 46 or 47, wherein: the processing circuitry of the host computer is configured to execute a host application, thereby providing request data; and the UE's processing circuitry is configured to execute a client application associated with the host application, thereby providing the user data in response to the request data.

51. A method implemented in a user equipment (UE), comprising one or more of the actions described herein as performed by the wireless device 131.

52. The method of embodiment 51, further comprising: providing user data; and forwarding the user data to a host computer via the transmission to the base station.

55. A method implemented in a communication system including a host computer, a base station and a user equipment (UE), the method comprising: at the host computer, receiving user data transmitted to the base station from the UE, wherein the UE performs one or more of the actions described herein as performed by the wireless device 131.

56. The method of embodiment 55, further comprising: at the UE, providing the user data to the base station.

57. The method of embodiment 56, further comprising: at the UE, executing a client application, thereby providing the user data to be transmitted; and at the host computer, executing a host application associated with the client application.

58. The method of embodiment 56, further comprising: at the UE, executing a client application; and at the UE, receiving input data to the client application, the input data being provided at the host computer by executing a host application associated with the client application, wherein the user data to be transmitted is provided by the client application in response to the input data.

61. A base station configured to communicate with a user equipment (UE), the base station comprising a radio interface and processing circuitry configured to perform one or more of the actions described herein as performed by the network node 110.

65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the network node 110.

66. The communication system of embodiment 65, further including the base station.

67. The communication system of embodiment 66, further including the UE, wherein the UE is configured to communicate with the base station.

68. The communication system of embodiment 67, wherein: the processing circuitry of the host computer is configured to execute a host application; the UE is configured to execute a client application associated with the host application, thereby providing the user data to be received by the host computer.

71. A method implemented in a base station, comprising one or more of the actions described herein as performed by the network node 110.

75. A method implemented in a communication system including a host computer, a base station and a user equipment (UE), the method comprising: at the host computer, receiving, from the base station, user data originating from a transmission which the base station has received from the UE, wherein the UE performs one or more of the actions described herein as performed by the wireless device 131.

76. The method of embodiment 75, further comprising: at the base station, receiving the user data from the UE.

77. The method of embodiment 76, further comprising: at the base station, initiating a transmission of the received user data to the host computer.

### REFERENCES

1. RP-213645, “New SID: Study on low-power Wake-up Signal and Receiver for NR”, RAN plenary #94, December 2021.

1. A method performed by a wireless device for handling a transmission, the wireless device operating in a wireless communications network, the method comprising:
monitoring, in sleep mode, using a first receiver to monitor first radio signals to wake-up the wireless device, whether or not a first radio signal is received from a node operating in the wireless communications network, wherein the first radio signal indicates the wireless device is in coverage of the node, wherein the monitoring is performed with the proviso the wireless device has obtained information to be sent to the node, wherein the first receiver is a wake-up-receiver (WUR), and the first radio signal is any signal detectable by the WUR; and
sending the obtained information to the node, the sending being based on whether or not the wireless device receives the first radio signal during the monitoring, wherein:
i) with the proviso the wireless device receives the first radio signal, the first radio signal wakes-up the wireless device from sleep mode by waking-up a second receiver to receive signals other than the first radio signals and the wireless device a) sends the information to the node while the wireless device is in coverage using the second receiver, b) goes back to sleep mode after the sending, and c) refrains from performing the monitoring with the proviso the wireless device lacks further information to be sent, and
ii) with the proviso the wireless device fails to receive the first radio signal, the wireless device: a) stores the information and b) stays in sleep mode, until the wireless device sends the information, using the second receiver, when the wireless device receives the first radio signal using the first receiver.

2. (canceled)

3. The method of claim 1, further
receiving the monitored first radio signal, and wherein the sending is based on the received first radio signal.

4. The method of claim 1, further comprising at least one of:
determining whether or not there is any information to be sent, and wherein the monitoring is performed with the proviso the wireless device determines that the information has been obtained, and
determining an energy level of the wireless device, and wherein the monitoring is performed with the proviso the determined energy level exceeds a first threshold.

5. The method of claim 1, further comprising:
obtaining an indication, the indication comprising a first configuration indicating how the wireless device is to perform the monitoring, and wherein the monitoring is performed based on the indicated first configuration.

6. (canceled)

7. The method of claim 1, the method further comprising:
determining whether or not the wireless device is in coverage based on whether or not the wireless device receives the first radio signal from the node, and wherein the sending of the information is:
i) performed only after the determination and
ii) based on a result of the determination.

8. The method of claim 1, further comprising:
determining whether or not the coverage of the node matches an uplink coverage, and wherein the sending of the information is performed with the proviso the match is determined.

9. The method of claim 1, wherein the second receiver remains in a power saving state during the monitoring.

10. A method performed by a node, the method being for handling a transmission, the node operating in a wireless communications network, and the method comprising:
sending a first radio signal, wherein the first radio signal indicates a wireless device operating in the wireless communications network, is in coverage of the node, wherein the first radio signal wakes up the wireless device from sleep mode when received by a first receiver used by the wireless device to monitor first radio signals to wake-up the wireless device, wherein the first receiver is a wake-up-receiver, and wherein the first radio signal is any signal detectable by the WUR; and
receiving information, from the wireless device, wherein the receiving is based on the sent first radio signal, and wherein the receiving is from a second receiver to receive signals other than the first radio signals, woken-up at the wireless device by the sent first radio signal.

11. The method of claim 10, the method further comprising:
sending an indication to the wireless device, the indication comprising a first configuration indicating how the wireless device is to monitor the first radio signal, and wherein the receiving is based on the indicated first configuration, and/or
adapting a power of transmission of the first radio signal, and wherein the first radio signal is transmitted with the adapted power, and wherein the receiving is based on the adapted transmitted first radio signal.

12. (canceled)

13. A wireless device for handling a transmission, the wireless device being configured to operate in a wireless communications network, and the wireless device being further configured to:
monitor, in sleep mode, using a first receiver to monitor first radio signals to wake-up the wireless device, whether or not a first radio signal is received from a node configured to operate in the wireless communications network, wherein the first radio signal is configured to indicate the wireless device is in coverage of the node, wherein the monitoring is configured to be performed with the proviso the wireless device has obtained information to be sent to the node, wherein the first receiver is configured to be a Wake-Up Receiver, WUR, and the first radio signal is configured to be any signal configured to be detectable by the WUR, and
send the information configured to be obtained to the node, the sending being configured to be based on whether or not the wireless device receives the first radio signal during the monitoring, wherein:
i) with the proviso the wireless device receives the first radio signal, the first radio signal is configured to wake-up the wireless device from sleep mode by waking-up a second receiver to receive signals other than the first radio signals and the wireless device send the information to the node while the wireless device is in coverage using the second receiver, b) go back to sleep mode after the sending, and c) refrain from performing the monitoring with the proviso the wireless device lacks further information to be sent, and
ii) with the proviso the wireless device fails to receive the first radio signal, the wireless device is configured to: a) store the information and b) stay in sleep mode, until the wireless device sends the information, using the second receiver, when the wireless device receives the first radio signal using the first receiver.

14. The wireless device of claim 13, wherein the sending of the information is configured to be performed in the absence of performing cell selection and/or cell reselection.

15. The wireless device of claim 13, being further configured to:
receive the first radio signal configured to be monitored, and wherein the sending is configured to be based on the first radio signal configured to be received.

16. The wireless device of claim 13, being further configured to at least one of:
determine whether or not there is any information to be sent, and wherein the monitoring is configured to be performed with the proviso the wireless device determines that the information has been obtained, and
determine an energy level of the wireless device, and wherein the monitoring is configured to be performed with the proviso the determined energy level exceeds a first threshold.

17. The wireless device of claim 13, being further configured to:
obtain an indication, the indication comprising a first configuration indicating how the wireless device is to perform the monitoring, and wherein the monitoring is configured to be performed based on the first configuration configured to be indicated.

18. (canceled)

19. The wireless device of claim 13, being further configured to:
determine whether or not the wireless device is in coverage based on whether or not the wireless device receives the first radio signal from the node, and wherein the sending of the information is configured to be:
i) performed only after the determination and
ii) based on a result of the determination.

20. The wireless device of claim 13, being further configured to:
determine whether or not the coverage of the node matches an uplink coverage, and wherein the sending of the information is configured to be performed with the proviso the match is determined.

21. The wireless device of claim 13, wherein the second receiver is configured to remain in a power saving state during the monitoring.

22. A node, for handling a transmission, the node being configured to operate in a wireless communications network, and the node being further configured to:
send a first radio signal, wherein the first radio signal is configured to indicate a wireless device configured to operate in the wireless communications network is in coverage of the node, wherein the first radio signal is configured to wake up the wireless device from sleep mode when received by a first receiver configured to be used by the wireless device to monitor first radio signals to wake-up the wireless device, wherein the first receiver is configured to be a Wake-Up Receiver, WUR, and wherein the first radio signal is configured to be any signal configured to be detectable by the WUR, and
receive information, from the wireless device, wherein the receiving is configured to be based on the first radio signal configured to be sent, and wherein the receiving is from a second receiver configured to receive signals other than the first radio signals, configured to be woken-up at the wireless device by the first radio signal configured to be sent.

23. The node of claim 22, being further configured to at least one of:
send an indication to the wireless device, the indication being configured to comprise a first configuration configured to indicate how the wireless device is to monitor the first radio signal, and wherein the receiving is configured to be based on the first configuration configured to be indicated, and
adapt a power of transmission of the first radio signal, and wherein the first radio signal is configured to be transmitted with the adapted power, and wherein the receiving is configured to be based on the transmitted first radio signal configured to be adapted.

24. The node of claim 22, wherein at least one of:
the first radio signal is configured to wake up the wireless device from sleep mode and it is configured to be different than a second radio signal wherein the second radio signal is configured to wake up the wireless device for downlink reachability,
the first radio signal is configured to be periodically sent,
the first radio signal is configured to be one of: cell specific and network specific,
the first radio signal is configured to be a WUR-Synchronisation Signal Block, SSB,
the first radio signal is configured to be coordinated with paging occasions configured to be used with signals to wake-up the wireless device, and the first radio signal is configured to be one of the signals to wake-up the wireless device,
the first radio signal is configured to be coordinated with paging occasions configured to be used with signals to wake-up the wireless device, and the first radio signal is configured to be different from and non-overlapping with the signals to wake-up the wireless device,
the signals to wake-up the wireless device and the first radio signal are configured to be jointly encoded,
at least one of a periodicity and a second configuration of the first radio signal is configured to change over time based on one or more conditions,
the receiving of the information is configured to be performed in the absence of performing cell selection and/or cell reselection, and
the periodicity of the first radio signal is configured to be linked to an operation mode of the WUR.
